(19) United States
(12) Patent Application Publication
(10) Pub. No.: US 2024/0236615 A1
(43) Pub. Date: Jul. 11, 2024

(54) Method and Apparatuses for Deferred Positioning of Wireless Devices

(71) Applicant: Telefonaktiebolaget LM Ericsson (publ), Stockholm (SE)

(72) Inventors: Ritesh Shreevastav, Upplands Väsby (SE); Åke Busin, Sollentuna (SE); Mohammed Yazid Lyazidi, Reading (GB)

(21) Appl. No.: 18/286,020

(22) PCT Filed: Apr. 11, 2022
(86) PCT No.: PCT/EP2022/059592

§ 371 Date: Oct. 6, 2023

Related U.S. Application Data
(60) Provisional application No. 63/173,081, filed on Apr. 9, 2021.

(51) Int. Cl. H04W 4/021; H04W 4/02

(52) U.S. Cl. CPC H04W 4/021; H04W 4/025

(57) ABSTRACT

A method performed by a wireless device comprises the step of sending (1202) a periodic location report for a location management function (54) of a wireless communication network (10), in accordance with configuration information, where the periodic location report is sent while the wireless device is operating within a geographic area (40) corresponding to assistance data provided to the wireless device (20) and includes positioning measurement or location information. The method further comprises receiving (1204) incremental assistance data for use by the wireless device (20) in generating a next periodic location report, the incremental assistance data indicating a qualified subset of transmission/reception points (12) of the wireless communication network (10) that are associated with the geographic area (40) and, with respect to generation of the next periodic location report by the wireless device (20), that are disallowed, allowed, or prioritized. (FIG. 12)

### TECHNICAL FIELD

Methods and apparatuses disclosed herein relate to wireless communication networks and, particularly, to deferred positioning of wireless communication devices.

### BACKGROUND

With reference to the positioning architecture defined for Fifth Generation New Radio (5G NR) in the Third Generation Partnership Project (3GPP) Technical Specification (TS) 38.305, an Application Management Function (AMF) receives a request for some location service associated with a particular target UE from another entity (e.g., a Gateway Mobile Location Center (GMLC) or the UE) or the AMF itself decides to initiate some location service on behalf of a particular target UE (e.g., for an IMS emergency call from the UE) as described in TS 23.502 and TS 23.273. The AMF then sends a location services request to a Location Management Function (LMF). The LMF processes the location services request, which processing may include transferring assistance data to the target UE to assist with UE-based and/or UE-assisted positioning and/or which may include positioning of the target UE. The LMF then returns the result of the location service back to the AMF (e.g., a position estimate for the UE). In the case of a location service requested by an entity other than the AMF (e.g., a GMLC or UE), the AMF returns the location service result to the entity.

A Next Generation (NG) Radio Access Network (RAN) node may control several Transmission/Reception Points or TRPs or Transmission Points (TPs), such as remote radio heads, or TPs that provide only Downlink (DL) Positioning Reference Signals (PRS) for support of a PRS-based Terrestrial Beacon System (TBS) for positioning.

An LMF may have a proprietary signaling connection to an Enhanced Serving Mobile Location Center (E-SMLC), which may enable the LMF to access information from an Evolved UMTS Terrestrial Radio Access Network (E-UTRAN). Such operations support, for example, E-UTRA positioning based on the Observed Time Difference of Arrival (OTDOA), using downlink measurements obtained by a target UE of signals from eNBs (5G base stations) and/or PRS-only TPs in the E-UTRAN.

Defined protocols support positioning of wireless devices (UEs) within the context of wireless communication networks operating according to 3GPP technical specifications. For example, LPP is the LTE Positioning Protocol and provides point-to-point communications between an LMF and a wireless device. NRPPa is the communication protocol between a gNB and an LMF.

5G networks support “deferred positioning,” including support for deferred mobile-terminated location request (MT-LR) event reporting. FIG. 1 depicts the sequence of operations for a Deferred MT-LR Event Reporting starting at the point where the UE reports an event to the LMF as described in TS 38.305.

As shown in step 1 in the figure, the UE sends a supplementary services event report message to the LMF as described in TS 24.571 which is transferred via the serving AMF and is delivered to the LMF using an Namf_Communication_N1MessageNotify service operation. The event report may indicate the type of event being reported and may include an embedded positioning message which includes any location measurements or location estimate.

As shown at step 2 in the figure, if the LMF determines no positioning procedure is needed, steps 3 and 4 are skipped.

As shown at step 3, the LMF may utilize any location information received in step 1. The LMF may also retrieve location related information from the UE and/or from the serving NG-RAN Node. In the former case, the LMF instigates one or more LPP procedures to provide assistance data to the UE and/or obtain location information from the UE. The UE may also instigate one or more LPP procedures after the first LPP message is received from the LMF (e.g., to request assistance data from the LMF).

At step 4, if the LMF needs location related information for the UE from the NG-RAN, the LMF instigates one or more NRPPa procedures. Step 3 is not necessarily serialized with step 2; if the LMF and NG-RAN Node have the information to determine what procedures need to take place for the location service, step 3 could precede or overlap with step 2.

At step 5, the LMF invokes an Nlmf_Location_EventNotify service operation towards the GMLC with an indication of the type of event being reported and any location estimate obtained as a result of steps 2 and 3.

In the context of 3GPP NR Rel-17, it has been agreed in RAN2 to discuss mechanism for signaling and procedures for reducing positioning latency in NR, with applicable to Downlink (DL) positioning methods and DL plus Uplink (UL) positioning methods. Areas of interest include latency reduction related to measurement gaps, latency reduction related to the reporting and request of the measurement (e.g., via Radio Resource Control (RRC) signaling, Medium Access Control—Control Element (MAC-CE) and/or physical layer procedures, and/or priority rules), latency reduction related to measurements, latency reduction related to the reporting and request of positioning assistance data (e.g., via location scheduling in advance of the time of when the location is needed).

Recognized herein is the need for improvements in positioning in the context of deferred MT-LR procedures and deferred Mobile-Originated (MO) LR procedures, and, more broadly, in any context involving deferred procedures where configurations, e.g., for positioning measurements and reporting, can be applied in advance of the time when the location is needed (i.e., pre-configuration scenarios).

For power saving reasons, DL positioning measurement in RRC_IDLE state and RRC_Inactive state will also be specified in 3GPP Rel-17. From a physical layer perspective, it is feasible for a UE to perform DL positioning measurement in RRC_IDLE state and RRC_Inactive state.

### SUMMARY

Certain aspects of the present disclosure and their embodiments may provide solutions to several challenges that remain. One aspect of the techniques and solutions described herein is the introduction of positioning area definitions, whereby a positioning area may be indicated as allowed, prioritized, or excluded. Definitional information comprises, for example, information regarding cells and/or TRPs, positioning methods, frequency information for deferred positioning operations, such as deferred MT-LR or deferred MO-LR procedures. With such information available to the LMF, the LFM may send the information or information derived therefrom, to the involved UE and/or to the involved network nodes via LPP. NRPPa, or LCS Signaling (message/Information Elements). Thus, for a particular UE, which cell/TRP list is valid can be communicated via dedicated signaling or UE associated signaling.

An example method according to some of the embodiments described herein is performed by a wireless device and comprises the step of sending a periodic location report for a location management function (LMF) of a wireless communication network, in accordance with configuration information, where the periodic location report is sent while the wireless device is operating within a geographic area corresponding to assistance data provided to the wireless device and the periodic location report includes positioning measurement or location information. The method further comprises receiving incremental assistance data for use by the wireless device in generating a next periodic location report, the incremental assistance data indicating a qualified subset of transmission/reception points (TRPs) of the wireless communication network that are associated with the geographic area and, with respect to generation of the next periodic location report by the wireless device, are disallowed, allowed, or prioritized.

Another example method according to some of the embodiments described herein is performed by a network node associated with a wireless communication network, such as an LMF, where the method comprises the step of receiving a periodic location report from a wireless device configured for periodical location reporting while operating within a geographic area corresponding to assistance data provided to the wireless device, the periodic location report including a positioning measurement or location information. The example method further comprises sending incremental assistance data for use by the wireless device in generating a next periodic location report, where the incremental assistance data indicates a qualified subset of transmission/reception points (TRPs) of the wireless communication network that are associated with the geographic area and, with respect to generation of the next periodic location report by the wireless device, that are disallowed, allowed, or prioritized.

Certain embodiments may provide one or more of the following technical advantage(s):
Introduction of a mechanism for allowing the network to know which cells a deferred positioning configuration should be active for, to reduce negative system impact. (If such network protection mechanism is not in place the alternative is that the network has no other option than to use same configuration for positioning all UEs, even when some UEs are outside factory premises or other areas of special consideration);
Reductions in network signaling by having not to signal all the Positioning (e.g., all DL-PRS) (Positioning Reference Signal; TS 37.355) configurations and only signaling allowed/excluded/prioritized information via dedicated signaling, as “delta” signaling sent for a certain deferred positioning procedure, with the generally-applicable positioning assistance data sent via broadcasting in one or more cells. This approach allows the network to send the “bare minimum” details to a particular UE and/or network node for an upcoming deferred positioning event/procedure, while providing the broader or more complete set of positioning assistance data via broadcasting.
The solution(s) described herein provide the network with mechanisms to exclude cells/TRPs which have high real-time differences between them (e.g., significant synchronization error), thus allowing the network to prevent such combinational use of such cells/TRPs in positioning of a particular UE in any particular deferred positioning event.
The solution(s) described herein allow the network to tailor positioning configurations in consideration of specific needs. For example, certain broadcast cells configurations (posSIB) may exist only when UE height needs to be computed (3-D view) and the disclosed signaling allows the network to indicate that such cells/TRPs are excluded from positioning measurements/procedure when only x, y coordinates are needed for the UE.
The solution(s) described herein improve efficiency by providing common configuration via broadcast, while using dedicated or unicast signaling to allowed or prioritized or excluded cells/TRPs for any particular deferred positioning event.
Overall, the solution(s) described herein provide for more compact and latency-friendly network signaling.

### BRIEF DESCRIPTION OF THE DRAWINGS

FIG. 1 depicts the sequence of operations for a Deferred MT-LR Event Reporting.

FIG. 2 is a block diagram of one embodiment of a wireless communication network.

FIGS. 3-6 are block diagrams of example embodiments for implementing Transmission/Reception Points (TRPs) and corresponding “service areas” of a wireless communication network, which may also be referred to as “coverage areas” and may be cell-based and may include the use of beams.

FIG. 7 is a diagram of an example geographic area within a larger geographic area, and where a wireless communication network supports positioning within or across such areas.

FIG. 8 is a block diagram of the wireless communication network of FIG. 1, according to a particular embodiment.

FIG. 9 is a block diagram of example embodiments of a Location Management Function (LFM), a network base station (BS), and a User Equipment (UE).

FIG. 10 is a logic flow diagram of one embodiment of a method of operation at an LMF.

FIG. 11 is a block diagram of one embodiment of an LMF.

FIG. 12 is a logic flow diagram of one embodiment of a method of operation at a UE.

FIG. 13 is a block diagram of one embodiment of a UE.

FIGS. 14 and 15 are block diagrams of example embodiments of a wireless device (UE) and a network node.

FIG. 16 illustrates an optimized signaling flow for a deferred positioning procedure

FIG. 17 illustrates an example of a gBN providing assistance data via cell broadcast.

FIG. 18 is a signaling flow diagram illustrates modified details of the MT-LR procedure.

FIG. 19 illustrates the positioning information exchange procedure, for a successful operation.

FIG. 20 illustrates the positioning area control procedure, for signaling between the LMF and the NG-RAN node and for signaling between the gNB-CU and the gNB-DU.

FIG. 21 illustrates an example of the LPP Location Information transfer procedure.

FIG. 22 is a block diagram of a wireless communication network according to some embodiments.

FIG. 23 is a block diagram of a user equipment according to some embodiments.

FIG. 24 is a block diagram of a virtualization environment according to some embodiments.

FIG. 25 is a block diagram of a communication network with a host computer according to some embodiments.

FIG. 26 is a block diagram of a host computer according to some embodiments.

FIG. 27 is a flowchart illustrating a method implemented in a communication system, in accordance with one embodiment.

FIG. 28 is a flowchart illustrating a method implemented in a communication system, in accordance with one embodiment.

FIG. 29 is a flowchart illustrating a method implemented in a communication system, in accordance with one embodiment.

FIG. 30 is a flowchart illustrating a method implemented in a communication system, in accordance with one embodiment.

### DETAILED DESCRIPTION

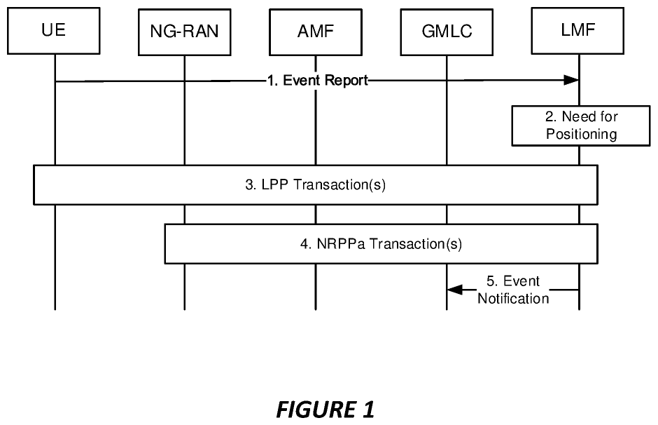

Within the framework described above, there exist certain challenges. For example, an LMF can decide the suitable positioning method(s) to be used in a UE and/or in a serving node of the wireless communication network, based on criteria such as: the type of client or UE, the QOS required, the positioning capabilities of the UE or the node, the TRPs in the network that collect the measurement, etc. In Deferred MT-LR, another factor that can come into this consideration is the UE potential Event Reporting (step 1 of the FIG. 1), where, for example, a UE would notify the network that it is leaving the indoor premise where it is located and move to another cell. In this regard, 3GPP TS 23.273 section 6.3.1 step 27 mentions, in fact, that LMF can decide to invoke what positioning method it finds appropriate once it receives such notification from the UE.

However, for positioning in, for example, industrial Internet-of-Things (IoT) scenarios, industrial premises, such as factories, can be in general very large and span many “cells” of the involved wireless communication network, e.g., such areas may be a large industrial area or city zone. Thus, the involved wireless communication network may have cells that are within the industrial area, which itself may have distinct sections or regions, and cells that are outside of the industrial area, and positioning considerations may be distinct for the two cases. A given geographic area can also span many TRPs of the network, for which there could be sub-groups of TRPs located in different cells. The area might also be “covered” by one macro-cell of the network, within which there are many TRPs deployed.

The same deferred positioning configuration or positioning method would thus not necessarily be applicable for locating a UE when it is within the factory premise area versus when it is in other areas of the network. Further, even within a factory or other industrial area, different sectors of the area may have different interference levels, obstruction/elevation levels, Non-Line-of-Sight (NLOS) issues, etc. Consequently, a specific recognition herein is that measurement configurations and/or positioning methods in deferred positioning scenarios may be advantageously tailored with respect to where the UE is or will be operating at the time the deferred positioning operations are carried out. However, many challenges arise, such as efficient signaling of configuration information.

Further, there are no defined procedures to help the wireless communication network (e.g., an LMF) know that the UE has entered an allowed area for deferred positioning procedures, or a prohibited one. Another aspect is that the network may only inform the UE on what interval the positioning needs to be determined, or when such info may be communicated by the UE to the network. Further, it is possible that all the assistance data required for positioning determination would then be broadcasted to the UE, i.e., mainly via the positioning system information broadcast such as in Table 1.

TABLE 1

| | | |
|---|---|---|
| OTDOA Assistance Data | posSibType3-1 | OTDOA-UE-Assisted |
| (clause 7.4.2) | | |
| Barometric Assistance | posSibType4-1 | Sensor-AssistanceDataList |
| Data | | |
| (clause 6.5.5.8) | | |
| TBS Assistance Data | posSibType5-1 | TBS-AssistanceDataList |
| (clause 6.5.4.8) | | |
| NR DL-TDOA/DL-AOD | posSibType6-1 | NR-DL-PRS-AssistanceData |
| Assistance Data | posSibType6-2 | NR-UEB-TRP-LocationData |
| (clauses 6.4.3, 7.4.2) | posSibType6-3 | NR-UEB-TRP-RTD-Info |

### (See 3GPP TS 37.355 v 16.3.0.)

In scenarios such as those described above, a UE may have already accumulated Assistance Data (AD) from several cells of the wireless communication network. However, from network perspective, the deferred or pre-configuration could be limited to certain cells/TRPs or applicable to only measurements for certain TRPs. Hence, efficient signaling mechanism as to what part of broadcast AD is applicable for the UE or not applicable in certain geographical area needs to be communicated to UE and significant challenges arise in that regard, as to efficiency and practicality.

To address these issues, one aspect of the techniques and solutions described herein is the introduction of positioning area definitions, whereby a positioning area may be indicated as allowed, prioritized, or excluded. Definitional information comprises, for example, information regarding cells and/or TRPs, positioning methods, frequency information for deferred positioning operations, such as deferred MT-LR or deferred MO-LR procedures. With such information available to the LMF, the LFM may send the information or information derived therefrom, to the involved UE and/or to the involved network nodes via LPP. NRPPa, or LCS Signaling (message/Information Elements). Thus, for a particular UE, which cell/TRP list is valid can be communicated via dedicated signaling or UE associated signaling.

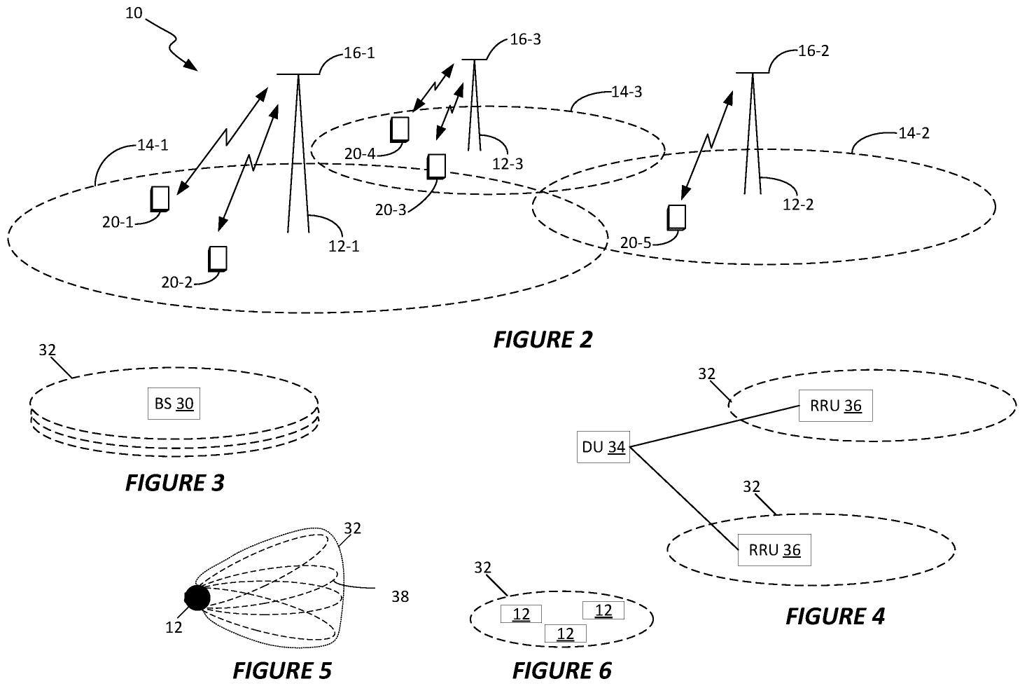

To put these techniques and solutions in context, FIG. 2 illustrates one embodiment of a wireless communication network 10, which includes a number of Transmission/Reception

Points (TRPs) 12, each providing radio coverage in one or more respective service areas 14, also referred to as coverage areas. For ease of illustration, only three TRPs 12 are shown, 12-1, 12-2, and 12-3, each providing a respective one of coverage areas 14-1, 14-2, and 14-3. The network 10 comprises, in an example embodiment, a 5G network proving NR air interfaces. However, such an example is non-limiting.

The coverage areas 14 may be understood as the use of particular resources-time, frequency, spatial (beam), etc.—to provide communication services to a respective geographic area. In one example, each TRP 14 includes or is associated with one or more transmit/receive antennas 16, which provide for downlink (DL) signal transmission to wireless devices 20 and uplink (UL) signal reception from wireless devices 20. Each TRP 12 may serve multiple wireless devices 20, and wireless devices 20 may move from one coverage area 14 to another. In that regard, neighboring coverage areas 14 may be overlapping.

FIG. 3 illustrates an example network base station (BS) 30, which provides one or more network “cells” 32. For example, the BS 30 may use different carrier frequencies or frequency bands for each such cell 32, such that cells operating on different frequency resources may cover the same geographic area or at least partly overlap in terms of geographic coverage. The BS 30 may be understood as one implementation of a TRP 12, and the cells 32 may be understood as example realizations of one or more coverage areas 14. Generally, at least some transmissions by the BS 30 include some sort of cell or BS identification.

FIG. 4 illustrates another approach to implementing a TRP 12 and one or more respective coverage areas 14. Here, a digital unit (DU) 34 interfaces with multiple remote radio units (RRUs) 36, with each RRU providing one or more cells 32. The interfaces between the DU 34 and the RRUs 36 are Common Public Radio Interfaces (CPRIs), for example.

FIG. 5 illustrates yet another approach to implementing a TRP 12 and one or more respective coverage areas. Here, a TRP 12, which may be a self-contained BS 30 or a distributed DU/RRU arrangement, provides a cell 32 via beamforming on the DL and/or the UL. Particularly, the TRP 12 provides radio coverage using beams 38, with each beam 38 having a particular direction (horizontal and/or vertical angles) and shape, and providing radio coverage along that beam direction. The TRP 12 may transmit multiple beams 38 at once, or it may use a sweeping or other pattern, in which it transmits one or a select few beams at a time, according to some repeating cycle.

Finally. FIG. 6 illustrates an example arrangement wherein one cell 32 contains multiple TRPs 12, with the respective coverage areas 14 of the individual TRPs all being part of the same cell 32. Such an arrangement may be realized, for example, using a distributed antenna system, or some other arrangement, such as the DU/RRU arrangement of FIG. 4.

One point to appreciate from FIGS. 2-6 is that there may be a one-to-one relationship between cells 32 and TRPs 12, or there may be a one-to-many relationship, such as seen in FIG. 6. Thus, a TRP 12 may be identified by providing its identity if it has a unique identity within the network domain of interest. Alternatively, a TRP may be identified, at least indirectly, according to a beam, cell, or sector identification with which it is associated.

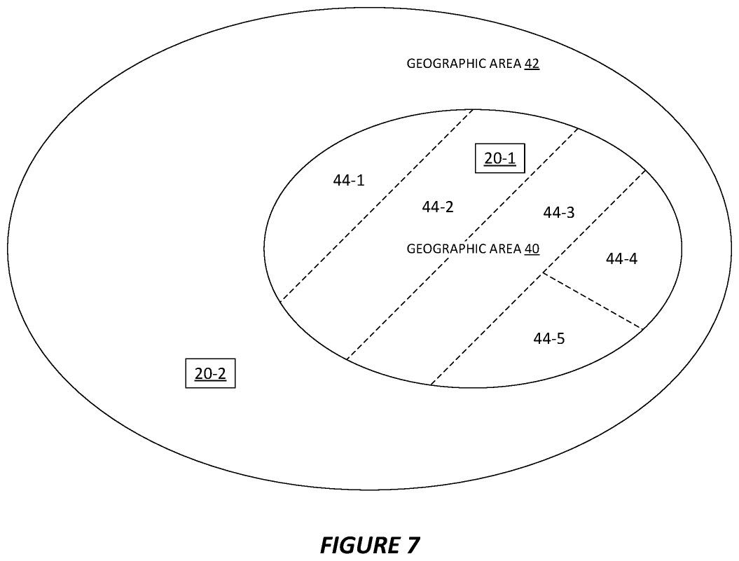

FIG. 7 illustrates an example arrangement of geographic areas, including a geographic area 40 that is contained within a larger geographic area 42. In one or more embodiments, the geographic area 40 may have different sectors or divisions 44. A communications network 10 provides communication-service coverage over the geographic areas 40 and 42. For example, the geographic area 42 may correspond to an overall set of cells 32 or, more generally, coverage areas 14, and the geographic area 40 may correspond to a particular subset of those cells 32 or coverage areas 14. As such, there may be an overall set or collection of TRPs 12 associated with the larger geographic area 42 and a subset of TRPs 12 associated with smaller geographic area 40.

As an example, the geographic area 40 represents an industrial area, such as a factory or warehouse, and positioning considerations for wireless devices 20 that are within the geographic area 40 may differ from those for wireless devices 20 that are outside of the geographic area 40. The figure shows a wireless device 20-1 operating inside the geographic area 40 and a wireless device 20-2 operating outside the geographic area 40. Of course, there may be many wireless devices 20 both inside and outside of the geographic area 40 and there may be wireless devices 20 within the geographic area 40 that are moving from one sector 44 to another sector 44, e.g., according to some known or estimable path or trajectory.

By way of example, five sectors 44-1 through 44-5 are shown. In one example, one or more wireless devices 14 comprise or are included on/in mobile robots or other mobile platforms, such as autonomous guided vehicles (AGVs) or the like, and they move within the geographic area 40, which may also be referred to as an “environment.” Although not a limiting example, one or more advantageous solutions proposed herein allow for the general broadcasting of (positioning) assistance data for the whole geographic area 40 and/or for the whole geographic area 42, with UE-specific “delta” or “incremental” signaling used to convey configuration information specific to a deferred positioning operation/event. Such information comprises, for example, an indication of the TRPs 12 that are allowed or prioritized or excluded for upcoming positioning measurements in a deferred positioning procedure.

Consequently, the network 10 is provided with a mechanism for efficient signaling and with the ability to improve or tailor the particular positioning measurements and/or the particular positioning method(s) used in an upcoming positioning event, by sending delta signaling that indicates the particular TRPs 12 that are allowed, prioritized, or excluded with respect to the positioning event. The indication may identify TRPs 12 by using indexes or pointers or other indications that refer to the larger set of assistance data broadcasted for the area(s) in question, and identifying a TRP 12 may comprise identifying the cells, sectors, beams, etc., that are allowed, prioritized, or excluded.

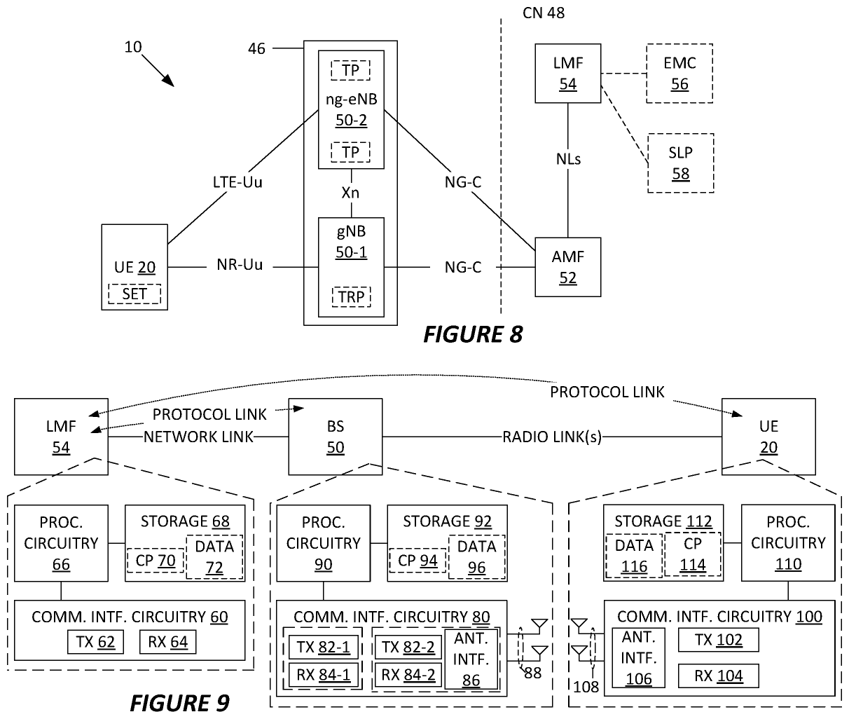

FIG. 8 illustrates an example embodiment of the communication network 10 introduced in FIG. 2. A Radio Access Network (RAN) 46 of the network 10 includes a gNB 50-1 (a 5G base station) and an ng-eNB 50-2 (an E-UTRAN base station coupled to a 5G Core Network or CN). Here, depiction of the CN 48 is simplified, with selected entities illustrated. Shown in the figure, the CN 48 includes an Application Management Function (AMF) 52, a Location Management Function (LMF) 54, which may be coupled with an Evolved Serving Mobile Location Center (EMC) 56 and/or a SUPL Location Platform (SLP) 58.

The interfaces/interconnections between the depicted entities conforms with 3GPP nomenclature for 5G networks. Other embodiments of the network 10 may have similar or equivalent entities but may use different nomenclature and/or interfaces. Also, the gNB 50-1 and eNB 50-1 each may provide or operate as one or more TRPs 12, or, at least in the context of positioning, one or both of them may operate as TPs only, e.g., transmitting one or more PRS or other reference signals for positioning measurements. With respect to the BS 30 depicted in FIG. 3, the gNB 50-1 and eNB 50-2 may be understood as specific examples of particular types of BSs 30.

FIG. 9 illustrates example embodiments of an LMF 54, a BS 50 (e.g., either BS 50-1 or 50-2), and a UE 20.

The example LMF 54 includes communication interface circuitry 60, including transmitter circuitry 62 and receiver circuitry 64. The communication interface circuitry 60 comprises, for example, physical-layer circuitry for wired or wireless transmission of signals and reception of signals. In one example, the communication interface circuitry 60 comprises a network communication interface, e.g., Ethernet or another data/signaling interface. The communication interface circuitry 60 is configured to communicatively coupled the LMF 54 to one or more other network nodes, such as AMFs 52, EMCs 56, SLPs 58, and/or BSs 50. Although the LMF 54 may use such circuitry for communicating with respective BSs 50, e.g., via an AMF 52, the LMF 54 also may use such circuitry for communicating with wireless devices 20 using AMF 52/BSs 50 as intermediary nodes in an overall end-to-end connection.

The LMF 54 further includes processing circuitry 66 which may include or be associated with storage 68, e.g., for storing one or more computer programs (CPs) 70 and/or one or more types of configuration data (DATA) 72. The storage 68 comprises one or more types of computer-readable media, such as one or more types of memory circuits or devices or storage devices, with non-limiting examples including SRAM, DRAM, FLASH, EEPROM, Solid State Disk (SSD), electromagnetic disk, etc. However, implemented, in one or more embodiments of the LMF 54, the storage 68 provides for non-transitory storage of computer program instructions that, when executed by one or more microprocessors or other digital processors, form the processing circuitry 66.

That is, the processing circuitry 66 may comprise one or more microprocessors, microcontrollers, or the like, that are specially adapted to carry out the operations described herein for the LMF 54, based on the execution of computer program instructions stored as one or more CPs 70 in the storage 68. More broadly, the processing circuitry 66 comprises fixed or dedicated circuitry, or programmatically-configured circuitry, or a mix of fixed and programmatically-configured circuitry.

The processing circuitry 66 is operatively associated with the communication interface circuitry 60. “Operatively associated” in this regard means that the processing circuitry 66 is operative to transmit and receive messages or other signaling via the communication interface circuitry. As such, when referring to the processing circuitry 66 receiving information or sending information, it may be understood that such receiving or sending may involve the processing circuitry 66 interacting with the communication interface circuitry 60.

The example BS 50 includes communication interface circuitry 80, including transmitter circuitry 82-1 and receiver circuitry 84-1. The transmitter circuitry 82-1 and the receiver circuitry 84-1 comprises, for example, physical-layer circuitry for wired or wireless transmission of signals and reception of signals. In one example, the transmitter circuitry 82-1 and the receiver circuitry 84-1 comprise a network communication interface, e.g., Ethernet or another data/signaling interface, for communicating with one or more other network nodes, such as other BSs 50 and/or with one or more nodes in the CN 48, such as AMFs 52 and/or LMFs 54.

The communication interface circuitry 80 further includes transmitter circuitry 82-2 and receiver circuitry 84-2, which may couple to one or more transmit/receive antennas 88 via antenna interface circuitry 86. The transmit/receive antennas 88 may comprise antenna arrays or multi-element antenna systems for transmit and/or receive beamforming. The transmitter circuitry 82-2 and the receiver circuitry 84-2 comprise, for example, radiofrequency circuitry and associated intermediate and/or baseband circuitry that is configured for providing a 5G NR air interface and/or other type of air interface, for transmitting DL signals to wireless devices 20 and receiving UL signals from wireless devices 20.

The BS 50 further includes processing circuitry 90 which may include or be associated with storage 92, e.g., for storing one or more computer programs (CPs) 94 and/or one or more types of configuration data (DATA) 96. The storage 92 comprises one or more types of computer-readable media, such as one or more types of memory circuits or devices or storage devices, with non-limiting examples including SRAM, DRAM, FLASH, EEPROM, Solid State Disk (SSD), electromagnetic disk, etc. However, implemented, in one or more embodiments of the BS 50, the storage 92 provides for non-transitory storage of computer program instructions that, when executed by one or more microprocessors or other digital processors, form the processing circuitry 90.

That is, the processing circuitry 90 may comprise one or more microprocessors, microcontrollers, or the like, that are specially adapted to carry out the operations described herein for the BS 50, based on the execution of computer program instructions stored as one or more CPs 94 in the storage 92. More broadly, the processing circuitry 90 comprises fixed or dedicated circuitry, or programmatically-configured circuitry, or a mix of fixed and programmatically-configured circuitry. The processing circuitry 90 is operatively associated with the communication interface circuitry 80, e.g., for sending and receiving signaling with respect to one or more other nodes in the network 10 and/or with respect to sending and receiving signaling with respect to wireless devices 20.

The example wireless device 20 (labeled UE in the figure) includes communication interface circuitry 100, including transmitter circuitry 102 and receiver circuitry 104, which may couple to one or more transmit/receive antennas 108 via antenna interface circuitry 106. The transmit/receive antennas 108 may comprise antenna arrays or multi-element antenna systems for transmit and/or receive beamforming. The transmitter circuitry 102 and the receiver circuitry 104 comprise, for example, radiofrequency circuitry and associated intermediate and/or baseband circuitry that is configured for transmitting and receiving on a 5G NR air interface and/or other type of air interface, for receiving DL signals and transmitting UL signals.

The wireless device 20 further includes processing circuitry 110 which may include or be associated with storage 112, e.g., for storing one or more computer programs (CPs) 114 and/or one or more types of configuration data (DATA) 116. The storage 112 comprises one or more types of computer-readable media, such as one or more types of memory circuits or devices or storage devices, with non-limiting examples including SRAM, DRAM, FLASH, EEPROM, Solid State Disk (SSD), electromagnetic disk, etc. However, implemented, in one or more embodiments of the wireless device 20, the storage 112 provides for non-transitory storage of computer program instructions that, when executed by one or more microprocessors or other digital processors, form the processing circuitry 110.

That is, the processing circuitry 110 may comprise one or more microprocessors, microcontrollers, or the like, that are specially adapted to carry out the operations described herein for the wireless device 20, based on the execution of computer program instructions stored as one or more CPs 114 in the storage 112. More broadly, the processing circuitry 110 comprises fixed or dedicated circuitry, or programmatically-configured circuitry, or a mix of fixed and programmatically-configured circuitry. The processing circuitry 110 is operatively associated with the communication interface circuitry 100, e.g., for sending and receiving signaling with respect to the network 10, e.g., with respect to TRPs 12 of the network 10.

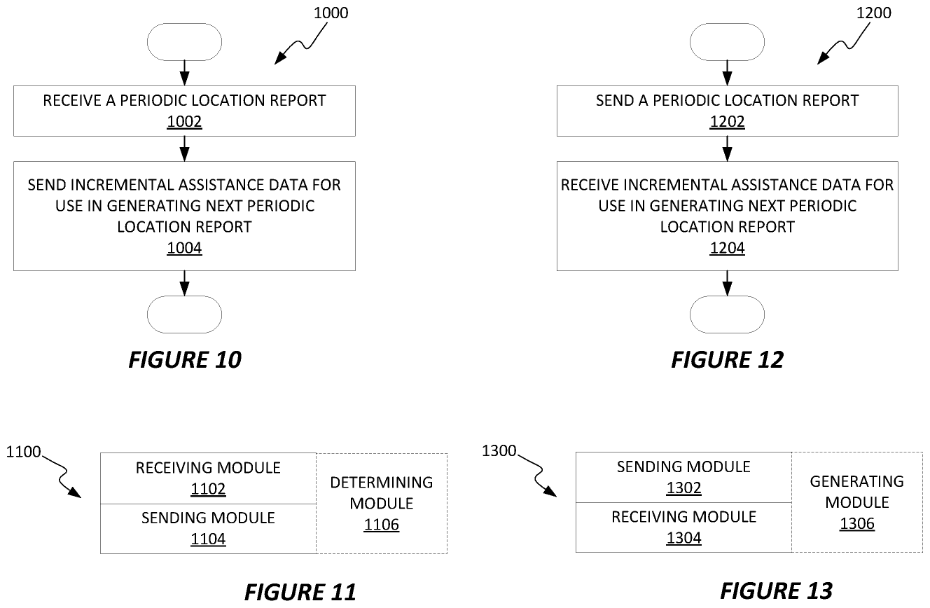

FIG. 10 illustrates a method 1000 performed by an LMF, e.g., the LMF 54 of FIG. 9 may be configured to carry out the operations of the method 1000. The method 1000 includes the LMF receiving a periodic location report (Block 1002), and sending incremental assistance data for use in generating a next periodic location report (Block 1004).

As a more detailed example, the LMF has configured a wireless device 20 for periodic positioning, as a form of “deferred” positioning, meaning that the wireless device 20 performs positioning periodically, or performs measurements periodically, in support of positioning. The wireless device 20 has “global” or general positioning assistance data covering the geographic area(s)/sectors(s) in which it is operating, such as may have been provided to the wireless device 20 by the LMF 54 via broadcasting in one or more cells 32 of the network 10.

Advantageously, however, the LMF 54 can tailor or control the particular positioning method and/or the particular positioning measurements made by the wireless device 20 in any of the periodic positioning events, based on sending efficient, delta or incremental signaling to the wireless device 20 in advance of any one of the events. For example, the LMF 54 may obtain, determine, or otherwise estimate a location of the wireless device 20, or estimate reception conditions, or determine positioning requirements, or other particulars associated with a next one of the periodic positioning events, and send incremental information to the wireless device 20, indicating the TRPs 12 that are allowed for, prioritized for, or excluded from the next positioning event.

This capability allows the LMF 54, for example, to account for where in an industrial or other environment the next positioning event will occur, or, at least, where that next event is expected to occur. More particularly, this capability allows the LMF 54 to optimize or otherwise tailor the particular TRPs 12 that are involved in the positioning event, or are prohibited from involvement.

FIG. 11 illustrates another embodiment of an LMF, where the LMF comprises a set of processing units or modules 1100, including a receiving module 1102, a sending module 1104, and a determining module 1106. The receiving module 1102 is configured, for example, to receive periodic location reports from a wireless device 20, the sending module 1104 is configured, for example, to transmit delta or incremental signaling for tailoring positioning operations for an upcoming or next one among periodic location reports, and the determining module 1106 is configured, for example, to determine the incremental information. The modules 1100 are realized, in an example embodiment, based on the execution of computer program instructions by one or more microprocessors or other digital processing circuits of the LMF.

FIG. 12 depicts one embodiment of a method 1200 of operation by a wireless device, such as the wireless device 20 in FIG. 9. The method 1200 includes sending a periodic location report (Block 1202), and receiving incremental assistance data—delta signaling—for use in generating a next periodic location report. Here, “next” may be the immediately forthcoming report according to the defined periodicity, or may be a further subsequent periodic report, or may be a batch or subset of forthcoming periodic location reports. Each location report may comprise positioning measurements and/or determined positioning information, according to the positioning method(s) in use.

In an example embodiment, the incremental assistance data indicates particular TRPs 12 of a wireless communication network, e.g., the network 10, that are allowed, prioritized, or excluded from consideration by the wireless device 20 in the next periodic location report. As noted, the wireless device may have received general positioning assistance data via broadcasting and may receive the incremental assistance data via unicasting. The general positioning assistance data may identify all TRPs 12 for a potentially broad geographic area, whereas the incremental assistance data is relevant to the position of the wireless device 20 when performing measurements in support of the next periodic location report. That location may be known or predicated by the LMF, with respect to generating the incremental assistance data.

FIG. 13 illustrates another embodiment of a wireless device, where the wireless device comprises a set of processing units or modules 1300, including a sending module 1302, a receiving module 1304, and a generating module 1306. The sending module 1302 is configured, for example, to send periodic location reports, the receiving module 1304 is configured, for example, to receive general assistance data and incremental assistance data (delta or incremental signaling for tailoring positioning operations for an upcoming or next one among periodic location reports), and the generating module 1306 is configured, for example, to generating positioning measurements or determine positioning information using the incremental information. The modules 1300 are realized, in an example embodiment, based on the execution of computer program instructions by one or more microprocessors or other digital processing circuits of the wireless device.

Embodiments herein also include corresponding apparatuses. Embodiments herein for instance include a wireless device configured to perform any of the steps of any of the embodiments described above for the wireless device.

Embodiments also include a wireless device comprising processing circuitry and power supply circuitry. The processing circuitry is configured to perform any of the steps of any of the embodiments described above for the wireless device. The power supply circuitry is configured to supply power to the wireless device.

Embodiments further include a wireless device comprising processing circuitry. The processing circuitry is configured to perform any of the steps of any of the embodiments described above for the wireless device. In some embodiments, the wireless device further comprises communication circuitry.

Embodiments further include a wireless device comprising processing circuitry and memory. The memory contains instructions executable by the processing circuitry whereby the wireless device is configured to perform any of the steps of any of the embodiments described above for the wireless device.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a radio network node configured to perform any of the steps of any of the embodiments described above for the radio network node.

Embodiments also include a radio network node comprising processing circuitry and power supply circuitry. The processing circuitry is configured to perform any of the steps of any of the embodiments described above for the radio network node. The power supply circuitry is configured to supply power to the radio network node.

Embodiments further include a radio network node comprising processing circuitry. The processing circuitry is configured to perform any of the steps of any of the embodiments described above for the radio network node. In some embodiments, the radio network node further comprises communication circuitry.

Embodiments further include a radio network node comprising processing circuitry and memory. The memory contains instructions executable by the processing circuitry whereby the radio network node is configured to perform any of the steps of any of the embodiments described above for the radio network node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

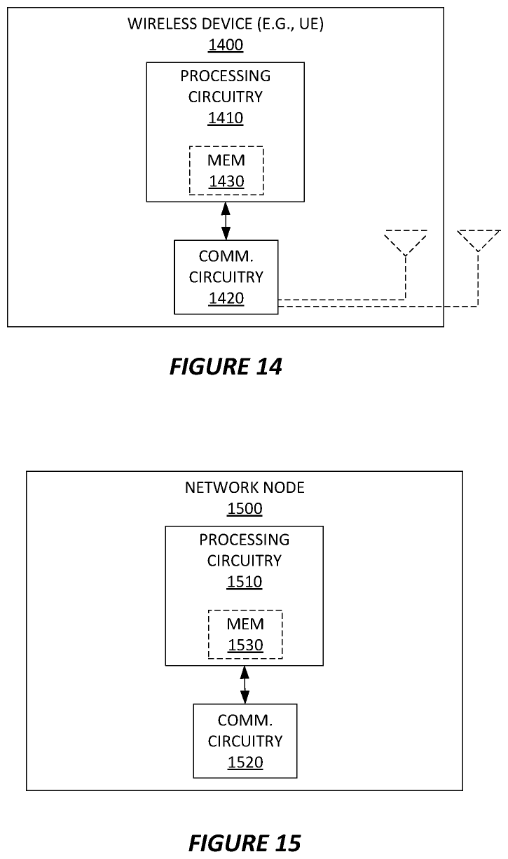

FIG. 14 for example illustrates a wireless device 1400 as implemented in accordance with one or more embodiments. As shown, the wireless device 1400 includes processing circuitry 1410 and communication circuitry 1420. The communication circuitry 1420 (e.g., radio circuitry) is configured to transmit and/or receive information to and/or from one or more other nodes, e.g., via any communication technology. Such communication may occur via one or more antennas that are either internal or external to the wireless device 1400. The processing circuitry 1410 is configured to perform processing described above, such as by executing instructions stored in memory 1430. The processing circuitry 1410 in this regard may implement certain functional means, units, or modules.

FIG. 15 illustrates a network node 1500 as implemented in accordance with one or more embodiments. As shown, the network node 1500 includes processing circuitry 1510 and communication circuitry 1520. The communication circuitry 1520 is configured to transmit and/or receive information to and/or from one or more other nodes, e.g., via any communication technology. The processing circuitry 1510 is configured to perform processing described above, such as by executing instructions stored in memory 1530. The processing circuitry 1510 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

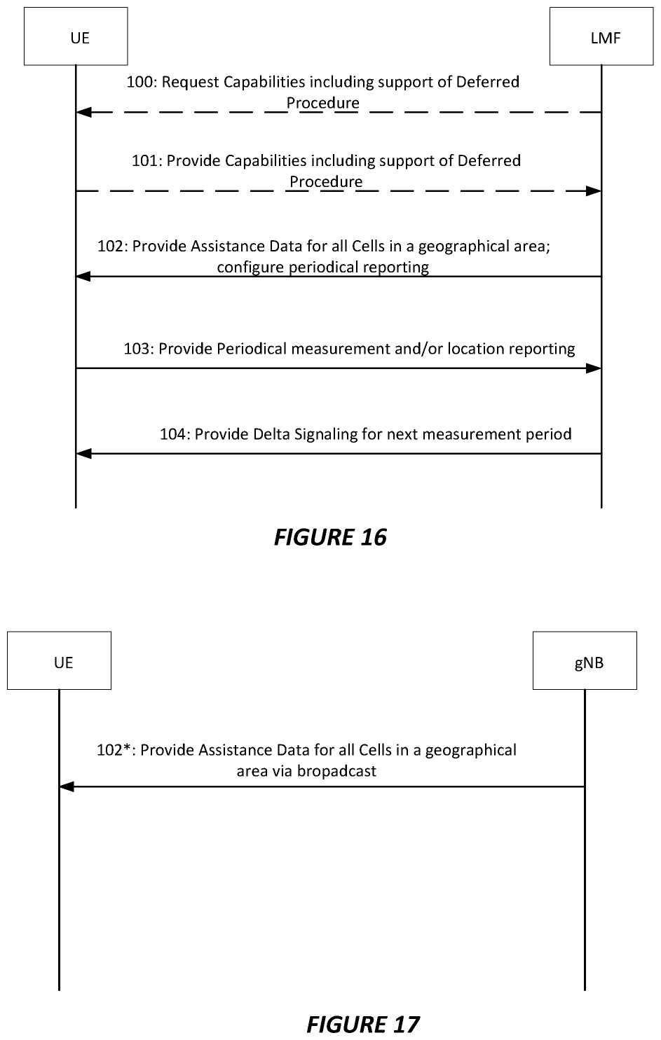

FIG. 16 illustrates an example signaling flow for deferred positioning measurements. The illustrated steps 100-104, and in particular steps 103 and 104, can be built in a loop, in some embodiments.

In step 100, the LMF requests UE capabilities which also includes request for providing support of deferred positioning procedure.

In step 101, the UE provides capabilities which also includes support of deferred positioning procedure.

In step 102, the LMF provides AD for all the cells confined in a geographical area; for example, for factory premises which may also include border area (outside factory premises and inside factory premises).

Additionally, step 102 may also be based upon the signaling, depicted in FIG. 17, which illustrates a gNB providing assistance data via cell broadcast.

Referring back to FIG. 16, in step 103, the UE performs measurement and provides measurement report to the LMF.

In step 104, the LMF provides any delta signaling with prioritized list/authorized list/prohibited list (e.g.: allowed (include)/exclude cell list, TRP List, Positioning methods, Positioning frequency layer list) on a continuous periodicity (synchronized to positioning periodical reporting from UE; i.e., just prior to positioning periodical reporting).

One motivation for step 104 is to provide UE specific prioritized (small or compact) signaling/indication, indicating what UE should prioritize for measurements for next periodical reporting from its stored configurations of all cells/TRPs. Effectively, the compact delta signaling provided allows the UE to filter or parse the larger information set of assistance data provided via broadcasting. This approach saves time at the UE for identifying best candidates for performing location measurement and provides faster correlation of the results in the LMF. The NW may learn/identify the cell list based upon previous UE experiences or OAM configuration (i.e., crowd-sourcing methods). For example; in certain section of factory; there may be a need to compute “Z” coordinate and hence only certain type of cells/beams that have vertical projection that would be relevant. Another example would be to restrict UE to perform measurements that it may have received from cell broadcast belonging to cells that are outside of factory/IIOT settings. In some cases, e.g. when UE in border area, the network (NW) may prioritize the UE to measure such outside cells. Here prioritization would imply to include/place the cells in the top list of include or allowed cell list for the UE to perform the measurements.

Step 104 may not be limited to cell list; it may also involve change of positioning method or request for additional measurements. For example, in a certain section of a factory there is good synchronization between TRPs; in such case only DL-TDOA based method may be adequate. However, in certain sections if there is not good synchronization other positioning method such as multi-RTT positioning procedure may be needed; thus, NW may request UE to provide UE Rx-Tx measurements apart from the TDOA measurements. Such change of positioning procedure can also be indicated as part of delta signaling.

Basic steps of a proposed embodiment from network node 1 (i.e., the LMF) perspective:
Step 100. Stores the information on areas with list of allowed cells/excluded cells (area ID such as tracking area code, TRPs for positioning).
Step 110. Receives the positioning request and the positioning capabilities of the target device from the AMF.
Step 120.
Selects the appropriate positioning method based on the target device capabilities.
Step 130. Send all Assistance data (e.g: DL-PRS configuration of all cells/TRPs) that is applicable in a geographical area;
Step 140.
   Sends the LCS signaling request to UE with allowed/restricted areas for deferred MT-LR event detection/reporting; or
   Sends the NRPPa positioning message with list of allowed cells for which the MT-LR, MO-LR, deferred positioning configuration is valid; and list of excluded cells for which the positioning configuration should not be used to the network node 2. Or
   Sends the LPP positioning measurement/configuration messages with a list of allowed/disallowed cells/TRPs for where measurement/configuration applies.
   Change Positioning procedure. The notification of allowed positioning method or restricted may also be beneficial if UE performs positioning based upon UE based method. Hence, it can identify the recommended positioning method that NW may suggest/provide. The NW has the information based upon the 3D map information of IIOT factory environment. Hence, with the deployment of TRPs it can identify the LOS/NLOS probability and may also have synchronization error information.
Step 150. Receives an event Report from the UE.

The steps 140 and 150 are repeated on continuous basis until positioning periodicity is completed.

The implementation of step 140 above or step 104 from FIG. 16 can be realized via LCS signaling or via NRPPa (RRC will also be used as part of this procedure) or via LPP signaling.

Basic steps of one proposed embodiment from network node 2 (i.e. gNB) perspective:
Step 200. Receives NRPPa positioning message with list of allowed cells/excluded cells for positioning
Step 210. If the UE is in RRC Connected or RRC Inactive state at one of the allowed cells, performs the UE-associated measurement/configuration as per the indicated NRPPa request message.

The allowed cell or valid cell or prioritized cell or forbidden cell list can also be designated by certain area code such as Radio network Area (RNA); tracking Area code, system Information Area ID (Relevant to 3GPP TS 38.331)

### LCS Based Signaling and Procedure

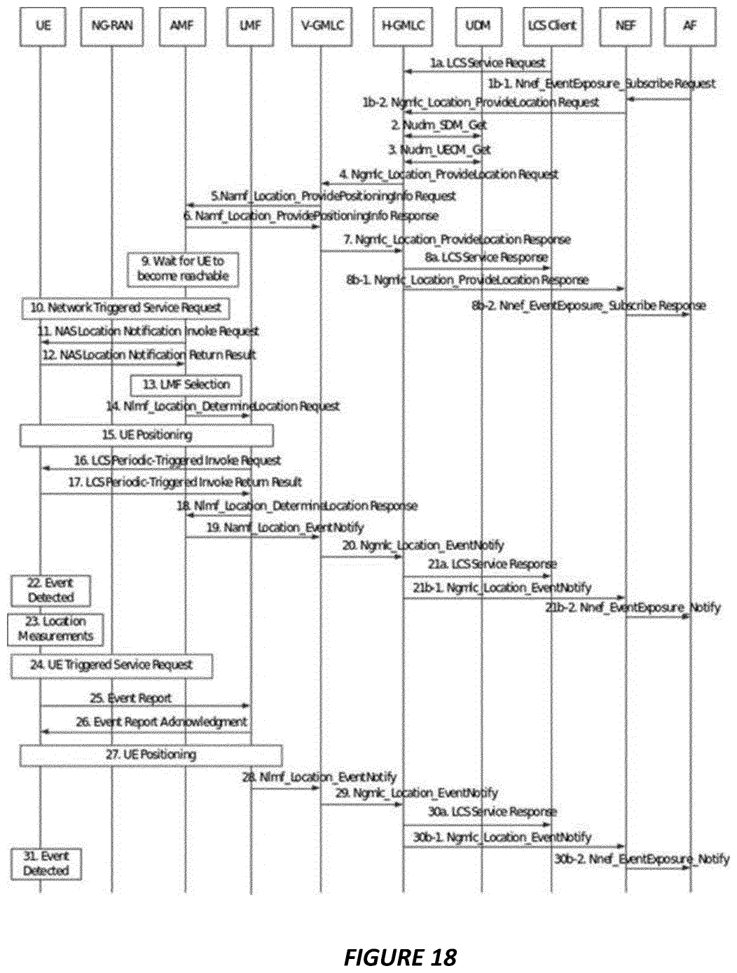

FIG. 18 illustrates the detailed signaling chart of the MT-LR procedure as might be defined in 3GPP TS 23.273 plus simplified description of relevant steps. New procedural change are found in steps 16 and 23. Discussion begins at step 15. References to specific clauses in the description of the steps below are references to clauses in 3GPP TS 23.273 unless otherwise indicated.

In step 15 of FIG. 18, the LMF performs one or more of the positioning procedures described in clause 6.11.1, 6.11.2 and 6.11.3 and as described for step 8 in clause 6.1.1. During this step, the LMF may request and obtain the UE positioning capabilities. The LMF may also obtain the UE location

In step 16, the LMF sends a supplementary services LCS Periodic-Triggered Invoke Request to the UE via the serving AMF. The LCS Periodic-Triggered Location Invoke carries the location request information received from the AMF at step 14. The Invoke may include an embedded positioning message which indicates certain allowed or required location measurements (or a location estimate) at step 24 for each location event reported (e.g. based on the positioning capabilities of the UE obtained in step 14 and the allowed access types) or a cell list, TRP list, Positioning Frequency Layer list, positioning methods list or a location estimate that were requested or allowed or prohibited or prioritized.

Note: Step 102 and/or 104 from FIG. 16 can be implemented at this step. That is by including the allowed or prohibited cell lists, TRP list, positioning methods or Assistance Data.

At step 17, the UE returns acknowledgment to the LMF.

At step 22, the UE monitors for occurrence of the trigger or periodic event requested in step 16. When a trigger or periodic event is detected, the UE proceeds to step 23.

At step 23, the UE obtains any location measurements, a cell list, TRP list, Positioning Frequency Layer list, positioning methods list or a location estimate that were requested or allowed or prohibited or prioritized at step 16.

At step 24, the UE performs a UE triggered service request as defined in clause 4.2.3.2 of 3GPP TS 23.502 if in CM-IDLE state in order to establish a signalling connection with the AMF.

At step 25, the UE sends a event report message to the LMF. The event report may include an embedded positioning message which includes any location measurements or location estimate obtained at step 23.

At step 26, the LMF returns an acknowledgment for the event report to the UE.

At step 27, if a location estimate is needed for event reporting, the LMF may perform one or more positioning procedures.

Note: Step 102 and/or 104 from FIG. 16 could be implemented at this step. This is currently not described in 3GPP TS 23.273. Further, 3GPP TS 23.273 do not define if any rules per 104 from FIG. 16 would apply at next instance of step 23.

### LCS Signalling:

The LCS ASN signalling might be implemented in 3GPP specifications according to the follow, for example, where new parts are found with respect to the fields periodicLocation and reportingareaList:

LCS-PeriodicTriggeredInvokeArg ::= SEQUENCE {

| referenceNumber | [0] | LCS-ReferenceNumber, | |
|---|---|---|---|
| h-gmlc-address | [1] | GSN-Address, | |
| qoS | [2] LCS-QoS | OPTIONAL, | |
| reportingPLMNList | [3] | ReportingPLMNList | OPTIONAL, |
| periodicLocation | [4] | PeriodicLocation | OPTIONAL, |

| | | | |
|---|---|---|---|
| areaEventReporting | [5] | AreaEventReporting | OPTIONAL, |
| motionEventReporting | [6] | MotionEventReporting | OPTIONAL, |

...,

| referenceNumberExt | [7] | LCS-ReferenceNumberExt | OPTIONAL, |
|---|---|---|---|
| h-gmlc-callBackUri | [8] | UTF8String OPTIONAL, | |
| supportedGADShapes | [9] | SupportedGADShapes | OPTIONAL, |

| | | | |
|---|---|---|---|
| deferredRoutingIdentifier | [10] | OCTET STRING | OPTIONAL, |

| | | | |
|---|---|---|---|
| reportingAccessTypes | [11] | ReportingAccessTypes | OPTIONAL, |

| | |
|---|---|
| multiplePositioningProtocolPDUs | [12] |

MultiplePositioningProtocolPDUs OPTIONAL,

| | |
|---|---|
| controlPlane-CIoT-5GS-Optimisation | [13] ControlPlane-CIoT-5GS- |

Optimisation OPTIONAL,

| | | |
|---|---|---|
| reportingareaList | [14] | AreaList} |

-- Only one of periodicLocation, areaEventReporting and
motionEventReporting shall be included.
-- responseTime and velocityRequest are not applicable in LCS-
QoS.
-- reportingPLMNList provides a list of PLMNs in which event
reporting is allowed.
-- reportingareaList provides a list of PLMNs in which event
reporting is allowed.
-- If referenceNumberExt is included, an MS shall ignore
referenceNumber.
-- h-gmlc-address shall be ignored by a UE for 5GS access.
-- referenceNumberExt, h-gmlc-callBackUri, supportedGADShapes,
deferredRoutingIdentifier,
-- reportingAccessTypes, multiplePositioningProtocolPDUs and
controlPlane-CIoT-5GS-Optimisation
-- shall not be included for E-UTRA access to EPC.
-- reportingPLMNList shall not be included for 5GS access.
PeriodicLocation ::= SEQUENCE {

| | | |
|---|---|---|
| periodicLDRInfo | [0] | PeriodicLDRInfo, |

... }
PeriodicLDRInfo ::= SEQUENCE {

| | |
|---|---|
| reportingAmount | ReportingAmount, |
| reportingInterval | Reporting Interval, |

...}
AreaList ::= SEQUENCE SIZE (1..maxAreas) OF Area
maxAreas INTEGER :: = 250
Area ::= SEQUENCE

| | |
|---|---|
| areaType | [0] AreaType, |

| | | |
|---|---|---|
| areaIdentification | [1] | AreaIdentification, |

...,

| | |
|---|---|
| areaIdentificationExt [2] | AreaIdentificationExt } |

```
AreaType ::= ENUMERATED {
  trackingArea (0),
  ecgi (1),
  ...,
  trackingArea5GS (2),
  ncgi (3) }
-- trackingArea5GS and ncgi shall not be included for an MS
without 5GS access
AreaIdentification ::= OCTET STRING (SIZE (5..7))
-- The internal structure is defined as follows:
```

| | |
|---|---|
| -- octet 1 | bits 4321 Mobile Country Code 1^{st} digit |
| | bits 8765 Mobile Country Code 2^{nd} digit |
| -- octet 2 | bits 4321 Mobile Country Code 3^{rd} digit |
| | bits 8765 Mobile Network Code 3^{rd} digit if 3 digit MNC |

included
-- or filler (1111)

| | |
|---|---|
| -- octet 3 | bits 4321 Mobile Network Code 1^{st} digit |
| -- | bits 8765 Mobile Network Code 2^{nd} digit |

-- octets 4 and 5 Tracking Area Code for an EPS Tracking Area (bit
8 of octet 4 is the
-- most significant bit and bit 1 of octet 5 the least
significant bit)
-- octets 4 until 7 E-UTRAN Cell Identity for an ECGI (bit 8 of
octet 4 is the most
-- significant bit and bit 5 of octet 7 the least significant
bit)
-- octets 4 until 6 Tracking Area Code for a 5GS Tracking Area
(bit 8 of octet 4 is the
-- most significant bit and bit 1 of octet 6 the least
significant bit)

| | |
|---|---|
| -- octets 4 until 7 | Cell Identity for an NCGI (bit 8 of octet |

4 is the most
-- significant bit and bit 1 of octet 7 the fifth least
significant bit. The 4 least

| | |
|---|---|
| -- | significant bits are included in |

areaIdentificationExt)
AreaIdentificationExt ::= OCTET STRING (SIZE (1))
-- contains the 4 least significant bits of an NCGI in bits 8765
with bit 8 containing the
-- the most significant bit

### Provide Allowed Area, Excluded Area for Deferred MT-LR Positioning:

One embodiment comprises a method executed by network node 1 LMF, the method comprising:
100. Storing the information on areas with list of allowed cells/excluded cells for MT-LR positioning. This step is assumed performed by OAM pre-configuration.
   101. In one embodiment, the allowed or excluded areas can be defined in terms of list of TRPs
110. Receiving the positioning request and the positioning capabilities of the target device from the AMF.
   111. The LMF selects a positioning method with a specific configuration that will be valid for a list of allowed cells or list of allowed TRPs.
   112. Alternatively, the LMF can link this positioning method or configuration to a specific systemInfoAreaID as defined in TS 37.355. The LMF could then have signalled the positioning assistance data (AD) to be broadcasted by the cells (containing e.g. a given PRS configuration) to other network nodes. The AD may be broadcasted by one cell to a number of TRPs. The LMF then decides to inform the UE to not monitor/use all the broadcast content, but to only follow the configuration and perform measurements in specific cells or TRP IDs; or exclude measurement in these.
   113. In one embodiment, the LMF can select different positioning methods; one valid for a list of cells/TRPs called, e.g., “List1”, and another valid for another list of cells/TRPs “List2”.
Step 120. sending the LCS signaling request to UE with allowed/restricted areas for deferred MT-LR procedure, as described in steps 111, 112 or 113

Or
130. Sending a NRPPa positioning message with list of allowed cells/TRP IDs for which the MT-LR positioning configuration is valid; and list of excluded cells for which the positioning configuration should not be used for the UE by the network node 2.
   131. In one embodiment, this information can be sent in existing UE associated NRPPa messages enhanced with new area restrictions information elements (IEs)
      E-CID MEASUREMENT INITIATION REQUEST,
      POSITIONING INFORMATION REQUEST
      POSITIONING ACTIVATION REQUEST
   132. In another embodiment, these lists of cells can be signalled in new NRPPa messages (see detailed structure example in 6.3)
   133. In another embodiment, the LMF can add a timer to inform the network node 2 gNB for how long this MT-LR configuration should be valid, or for how long to use some specific positioning characteristics (e.g. use semi-periodic SRS for time ‘T’, then switch to periodic, etc.)

Or
140. Sending a LPP positioning message with list of allowed cells/TRP IDs for which the MT-LR positioning configuration is valid; and list of excluded cells for which the positioning configuration should not be used for the UE by the network node 2.
   141. embodiment, this information can be sent in existing or new LPP messages
   142. Same as for 133, a timer can be added in the LPP message.

One embodiment herein comprises a method executed by network node 2 gNB, where the method comprises:
Step 200. Receiving the NRPPa positioning message with the list of allowed cells/excluded cells for positioning that the UE will consider.
   201. In case of split gNB architecture, the gNB-CU sends the list of allowed cells/excluded cells for MT-LR positioning to the gNB-DU over appropriate F1AP messages (existing F1 messages or new procedures as mentioned in 130)
Step 210. performing the positioning measurement/configuration
   202. In one embodiment, if the message includes list(s) of allowed cells, the gNB shall enable its TRPs to perform the specific positioning measurements only in those indicated cells.
   203. If the message includes list of excluded cells, the gNB shall ignore the positioning configuration for UEs located in those cells, and no positioning procedure takes place in that area.

One embodiment herein comprises a method executed by UE the method comprising:
Step 300. Receiving the request from LMF to start the deferred MT-LR Event procedure in allowed area, and/or to not start it in restricted area via LCS signalling
Step 310. Sends an LPP acknowledgement with LCS message to the LMF

### NRPPa In-Message Signaling Example:

What follows a non-limiting example of enhancing an existing NRPPa “POSITIONING INFORMATION REQUEST” message with list of authorized TRPs/prohibited TRPs from LMF to gNB, described in both procedural and tabular forms. This is corresponding to the message in step 131, discussed above.

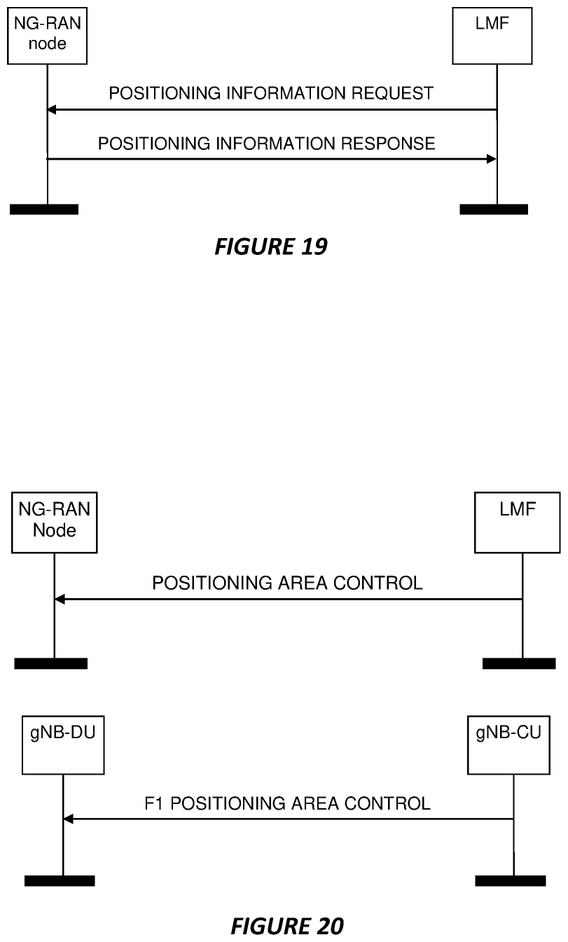

FIG. 19 illustrates the positioning information exchange procedure, for a successful operation.

The information elements are described in Table 2, for signaling in the direction of LMF towards the NG-RAN node.

TABLE 2

| IE/Group | | | IE type and | Semantics | | Assigned |
|---|---|---|---|---|---|---|
| Name | Presence | Range | reference | description | Criticality | Criticality |
| Message Type | M | | 9.2.3 | | YES | reject |
| NRPPa | M | | 9.2.4 | | — | |
| Transaction ID | | | | | | |
| Authorized | | | | | YES | Reject |
| TRPs List | | | | | | |
| >TRP Item | | 1 . . .<maxnoTRPs> | | | EACH | Reject |
| >>TRP ID | M | | 9.2.24 | | — | |
| >>Deferred | O | | OCTET | Indicates the time for | — | |
| Timer | | | STRING | which the deferred | | |
| | | | | positioning | | |
| | | | | configuration is valid | | |
| | | | | in the authorized | | |
| | | | | area | | |
| >> | O | | ENUMERATED | The positioning | | |
| Positioning | | | | method that should | | |
| method | | | | be used for locating | | |
| | | | | the UE in the | | |
| | | | | allowed area | | |
| Prohibited | | | | | YES | Reject |
| TRPs List | | | | | | |
| >TRP Item | | 1 . . . <maxnoTRPs> | | | EACH | Reject |
| >>TRP ID | M | | 9.2.24 | | — | |
| Requested SRS | O | | 9.2.27 | | YES | ignore |
| Transmission | | | | | | |
| Characteristics | | | | | | |

### NRPPa Signaling:

What follows is a non-limiting example of a new NRPPa “POSITIONING AREA CONTROL” message, with list of authorized TRPs/prohibited TRPs from LMF to gNB, described in both procedural and tabular forms. This corresponds to the message in step 132.

FIG. 20 illustrates the positioning area control procedure.

The POSITIONING AREA CONTROL message may be defined as shown in Table 3. This message is sent from the LMF to inform the NG-RAN node of the authorized and prohibited areas for deferred positioning of the UE, thus, the direction is from LMF to NG-RAN node.

TABLE 3

| | | | IE type and | |
|---|---|---|---|---|
| IE/Group Name | Presence | Range | reference | Semantics description |
| Message Type | M | | 9.2.3 | |
| NRPPa Transaction ID | M | | 9.2.4 | |
| | | | | Authorized area for |
| Authorized TRPs List | | 0 . . . 1 | | deferred positioning |
| >TRP Item | | 1 . . . | | |
| | | <maxnoTRPs> | | |
| >>TRP ID | M | | 9.2.24 | |
| >>Deferred Timer | O | | OCTET STRING | Indicates the time for which |
| | | | | the deferred positioning |
| | | | | configuration is valid in the |
| | | | | authorized area |
| >> Positioning method | O | | ENUMERATED | The positioning method |
| | | | | that should be used for |
| | | | | locating the UE in the |
| | | | | allowed area |
| >> Frequency layer | O | | ENUMERATED | |
| list information | | | | |
| | | | | Prohibited area for |
| Prohibited TRPs List | | 0 . . . 1 | | deferred positioning |
| >TRP Item | | 1 . . . | | |
| | | <maxnoTRPs> | | |
| >>TRP ID | M | | 9.2.24 | |

| Range bound | Explanation |
|---|---|
| maxnoTRPs | Maximum no. of TRPs in a NG-RAN node. Value is 65535 |

### F1AP Signaling:

The following is a non-limiting example of new F1AP signaling, procedural and tabular forms, corresponding to embodiment 201. An example of the F1AP Positioning Area Control procedure is shown in the bottom portion of FIG. 20.

The F1AP POSITIONING AREA CONTROL message is sent from the gNB-CU to inform the gNB-DU of the authorized and prohibited areas for deferred positioning for the UE. Thus, the direction is from the gNB-CU to the gNB-DU. Table 4 illustrates details of an example implementation of this message.

TABLE 4

| | | | IE type and | |
|---|---|---|---|---|
| IE/Group Name | Presence | Range | reference | Semantics description |
| Message Type | M | | 9.3.1.1 | |
| Transaction ID | M | | 9.3.1.23 | |
| Authorized TRPs | | | | Authorized area for deferred |
| List | | 0 . . . 1 | | positioning |
| >TRP Item | | 0 . . . <maxnoofTRPs> | | |
| >>TRP ID | M | | 9.3.1.197 | |
| >>Deferred | O | | OCTET | Indicates the time for which the |
| Timer | | | STRING | deferred positioning configuration is |
| | | | | valid in the authorized area |
| >> Positioning | O | | ENUMERATED | The positioning method that should |
| method | | | | be used for locating the UE in the |
| | | | | allowed area |
| >> Frequency | 0 | | ENUMERATED | |
| layer list | | | | |
| information | | | | |
| Prohibited TRPs | | | | Prohibited area for deferred |
| List | | 0 . . . 1 | | positioning |
| >TRP Item | | 0 . . . <maxnoofTRPs> | | |
| >>TRP ID | M | | 9.3.1.197 | |

| Range bound | Explanation |
|---|---|
| maxnoofTRPs | Maximum no. of TRPs in a NG-RAN node. Value is 65535 |

### LPP Signaling:

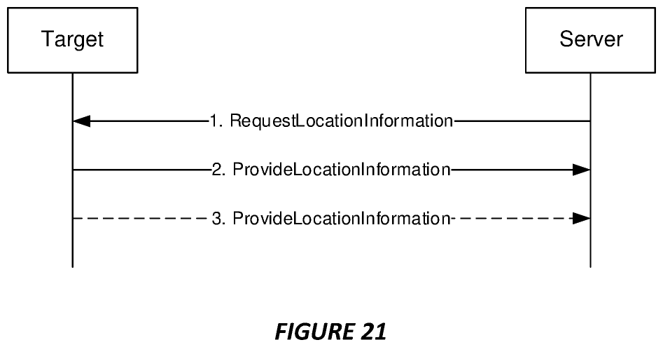

FIG. 21 illustrates an example of the LPP Location Information transfer procedure.

Below are details of the messaging in this procedure, according to an example possible implementation in 3GPP specifications. Now details are found with respect to the Validarelist field.

RequestLocationInformation ::= SEQUENCE {

| | |
|---|---|
| criticalExtensions | CHOICE { |
| c1 | CHOICE { |
| requestLocationInformation-r9 | RequestLocationInformation-r9-IEs, |

```
      spare3 NULL, spare2 NULL, spare1 NULL
    },
    criticalExtensionsFuture SEQUENCE { }
  }
}
RequestLocationInformation-r9-IEs ::= SEQUENCE {
  commonIEsRequestLocationInformation
```

CommonIEsRequestLocationInformation

OPTIONAL,
.
.
}
CommonIEsRequestLocationInformation ::= SEQUENCE {

| locationInformationType | LocationInformationType, | |
|---|---|---|
| triggeredReporting | TriggeredReportingCriteria | OPTIONAL, -- Cond |

ECID

| | |
|---|---|
| periodicalReporting | PeriodicalReportingCriteria OPTIONAL, -- Need |

ON

| | | |
|---|---|---|
| additionalInformation | AdditionalInformation | OPTIONAL, -- Need ON |
| qos | QoS | OPTIONAL, -- Need ON |
| environment | Environment | OPTIONAL, -- Need |

ON

| | | |
|---|---|---|
| locationCoordinateTypes | LocationCoordinateTypes | OPTIONAL, -- Need |

ON

| | | |
|---|---|---|
| velocityTypes | VelocityTypes | OPTIONAL, -- Need ON |

```
  ...,
  [[
```

| | | |
|---|---|---|
| messageSizeLimitNB-r14 | MessageSizeLimitNB-r14 | OPTIONAL -- Need ON |

]],
[[

| | | |
|---|---|---|
| segmentationInfo-r14 | SegmentationInfo-r14 | OPTIONAL -- Need ON |

]],
[[

| | | |
|---|---|---|
| validarealist-rxx | Validarealist-rxx | OPTIONAL -- Need ON |

]]
}
Validarealist-rxx ::= SEQUENCE SIZE (1..maxValidAreas) OF NCGI-r15

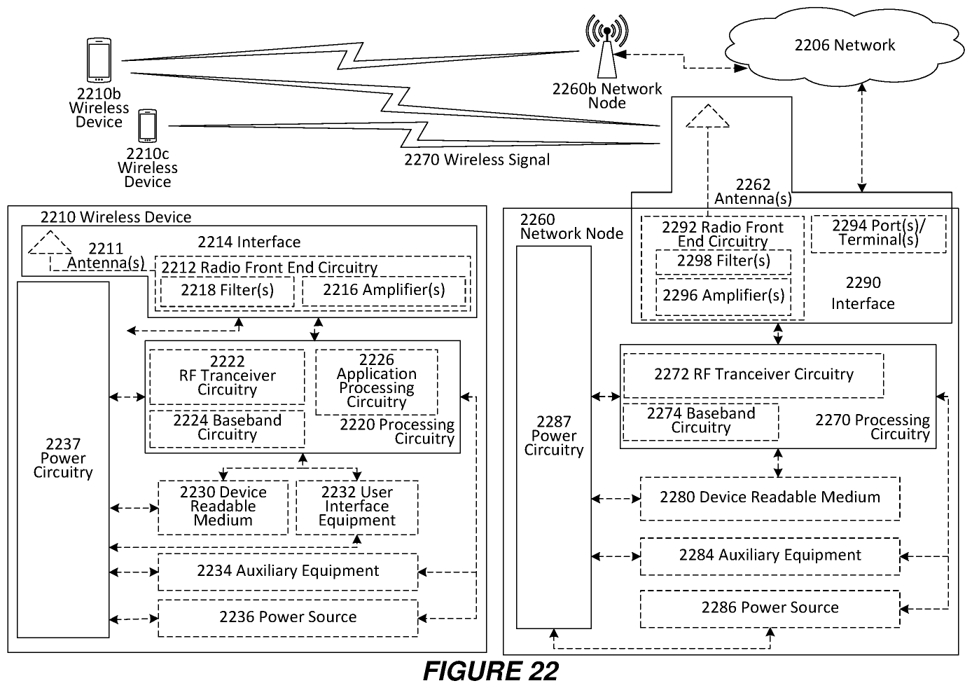

Although the subject matter described herein may be implemented in any appropriate type of system using any suitable components, the embodiments disclosed herein are described in relation to a wireless network, such as the example wireless network illustrated in FIG. 22. For simplicity, the wireless network of FIG. 22 only depicts network 2206, network nodes 2260 and 2260b, and wireless devices 2210, 2210b, and 2210c. In practice, a wireless network may further include any additional elements suitable to support communication between wireless devices or between a wireless device and another communication device, such as a landline telephone, a service provider, or any other network node or end device. Of the illustrated components, network node 2260 and wireless device 2210 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2206 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2260 and wireless device 2210 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 22, network node 2260 includes processing circuitry 2270, device readable medium 2280, interface 2290, auxiliary equipment 2284, power source 2286, power circuitry 2287, and antenna 2262. Although network node 2260 illustrated in the example wireless network of FIG. 22 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 2260 are depicted as single boxes located within a larger box, or nested within multiple boxes, in practice, a network node may comprise multiple different physical components that make up a single illustrated component (e.g., device readable medium 2280 may comprise multiple separate hard drives as well as multiple RAM modules).

Similarly, network node 2260 may be composed of multiple physically separate components (e.g., a NodeB component and a RNC component, or a BTS component and a BSC component, etc.), which may each have their own respective components. In certain scenarios in which network node 2260 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 2260 may be configured to support multiple radio access technologies (RATs). In such embodiments, some components may be duplicated (e.g., separate device readable medium 2280 for the different RATs) and some components may be reused (e.g., the same antenna 2262 may be shared by the RATs). Network node 2260 may also include multiple sets of the various illustrated components for different wireless technologies integrated into network node 2260, such as, for example, GSM, WCDMA, LTE, NR, WiFi, or Bluetooth wireless technologies. These wireless technologies may be integrated into the same or different chip or set of chips and other components within network node 2260.

Processing circuitry 2270 is configured to perform any determining, calculating, or similar operations (e.g., certain obtaining operations) described herein as being provided by a network node. These operations performed by processing circuitry 2270 may include processing information obtained by processing circuitry 2270 by, for example, converting the obtained information into other information, comparing the obtained information or converted information to information stored in the network node, and/or performing one or more operations based on the obtained information or converted information, and as a result of said processing making a determination.

Processing circuitry 2270 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2260 components, such as device readable medium 2280, network node 2260 functionality. For example, processing circuitry 2270 may execute instructions stored in device readable medium 2280 or in memory within processing circuitry 2270. Such functionality may include providing any of the various wireless features, functions, or benefits discussed herein. In some embodiments, processing circuitry 2270 may include a system on a chip (SOC).

In some embodiments, processing circuitry 2270 may include one or more of radio frequency (RF) transceiver circuitry 2272 and baseband processing circuitry 2274. In some embodiments, radio frequency (RF) transceiver circuitry 2272 and baseband processing circuitry 2274 may be on separate chips (or sets of chips), boards, or units, such as radio units and digital units. In alternative embodiments, part or all of RF transceiver circuitry 2272 and baseband processing circuitry 2274 may be on the same chip or set of chips, boards, or units

In certain embodiments, some or all of the functionality described herein as being provided by a network node, base station, eNB or other such network device may be performed by processing circuitry 2270 executing instructions stored on device readable medium 2280 or memory within processing circuitry 2270. In alternative embodiments, some or all of the functionality may be provided by processing circuitry 2270 without executing instructions stored on a separate or discrete device readable medium, such as in a hard-wired manner. In any of those embodiments, whether executing instructions stored on a device readable storage medium or not, processing circuitry 2270 can be configured to perform the described functionality. The benefits provided by such functionality are not limited to processing circuitry 2270 alone or to other components of network node 2260, but are enjoyed by network node 2260 as a whole, and/or by end users and the wireless network generally.

Device readable medium 2280 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 2270. Device readable medium 2280 may store any suitable instructions, data or information, including a computer program, software, an application including one or more of logic, rules, code, tables, etc. and/or other instructions capable of being executed by processing circuitry 2270 and, utilized by network node 2260. Device readable medium 2280 may be used to store any calculations made by processing circuitry 2270 and/or any data received via interface 2290. In some embodiments, processing circuitry 2270 and device readable medium 2280 may be considered to be integrated.

Interface 2290 is used in the wired or wireless communication of signalling and/or data between network node 2260, network 2206, and/or wireless devices 2210. As illustrated, interface 2290 comprises port(s)/terminal(s) 2294 to send and receive data, for example to and from network 2206 over a wired connection. Interface 2290 also includes radio front end circuitry 2292 that may be coupled to, or in certain embodiments a part of, antenna 2262. Radio front end circuitry 2292 comprises filters 2298 and amplifiers 2296. Radio front end circuitry 2292 may be connected to antenna 2262 and processing circuitry 2270. Radio front end circuitry may be configured to condition signals communicated between antenna 2262 and processing circuitry 2270. Radio front end circuitry 2292 may receive digital data that is to be sent out to other network nodes or wireless devices via a wireless connection. Radio front end circuitry 2292 may convert the digital data into a radio signal having the appropriate channel and bandwidth parameters using a combination of filters 2298 and/or amplifiers 2296. The radio signal may then be transmitted via antenna 2262. Similarly, when receiving data, antenna 2262 may collect radio signals which are then converted into digital data by radio front end circuitry 2292. The digital data may be passed to processing circuitry 2270. In other embodiments, the interface may comprise different components and/or different combinations of components.

In certain alternative embodiments, network node 2260 may not include separate radio front end circuitry 2292, instead, processing circuitry 2270 may comprise radio front end circuitry and may be connected to antenna 2262 without separate radio front end circuitry 2292. Similarly, in some embodiments, all or some of RF transceiver circuitry 2272 may be considered a part of interface 2290. In still other embodiments, interface 2290 may include one or more ports or terminals 2294, radio front end circuitry 2292, and RF transceiver circuitry 2272, as part of a radio unit (not shown), and interface 2290 may communicate with baseband processing circuitry 2274, which is part of a digital unit (not shown).

Antenna 2262 may include one or more antennas, or antenna arrays, configured to send and/or receive wireless signals. Antenna 2262 may be coupled to radio front end circuitry 2290 and may be any type of antenna capable of transmitting and receiving data and/or signals wirelessly. In some embodiments, antenna 2262 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 2262 may be separate from network node 2260 and may be connectable to network node 2260 through an interface or port.

Antenna 2262, interface 2290, and/or processing circuitry 2270 may be configured to perform any receiving operations and/or certain obtaining operations described herein as being performed by a network node. Any information, data and/or signals may be received from a wireless device, another network node and/or any other network equipment. Similarly, antenna 2262, interface 2290, and/or processing circuitry 2270 may be configured to perform any transmitting operations described herein as being performed by a network node. Any information, data and/or signals may be transmitted to a wireless device, another network node and/or any other network equipment.

Power circuitry 2287 may comprise, or be coupled to, power management circuitry and is configured to supply the components of network node 2260 with power for performing the functionality described herein. Power circuitry 2287 may receive power from power source 2286. Power source 2286 and/or power circuitry 2287 may be configured to provide power to the various components of network node 2260 in a form suitable for the respective components (e.g., at a voltage and current level needed for each respective component). Power source 2286 may either be included in, or external to, power circuitry 2287 and/or network node 2260. For example, network node 2260 may be connectable to an external power source (e.g., an electricity outlet) via an input circuitry or interface such as an electrical cable, whereby the external power source supplies power to power circuitry 2287. As a further example, power source 2286 may comprise a source of power in the form of a battery or battery pack which is connected to, or integrated in, power circuitry 2287. The battery may provide backup power should the external power source fail. Other types of power sources, such as photovoltaic devices, may also be used.

Alternative embodiments of network node 2260 may include additional components beyond those shown in FIG. 22 that may be responsible for providing certain aspects of the network node's functionality, including any of the functionality described herein and/or any functionality necessary to support the subject matter described herein. For example, network node 2260 may include user interface equipment to allow input of information into network node 2260 and to allow output of information from network node 2260. This may allow a user to perform diagnostic, maintenance, repair, and other administrative functions for network node 2260.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 2210 includes antenna 2211, interface 2214, processing circuitry 2220, device readable medium 2230, user interface equipment 2232, auxiliary equipment 2234, power source 2236 and power circuitry 2237. Wireless device 2210 may include multiple sets of one or more of the illustrated components for different wireless technologies supported by wireless device 2210, such as, for example, GSM, WCDMA, LTE, NR. WiFi, WiMAX, NB-IoT, or Bluetooth wireless technologies, just to mention a few. These wireless technologies may be integrated into the same or different chips or set of chips as other components within wireless device 2210.

Antenna 2211 may include one or more antennas or antenna arrays, configured to send and/or receive wireless signals, and is connected to interface 2214. In certain alternative embodiments, antenna 2211 may be separate from wireless device 2210 and be connectable to wireless device 2210 through an interface or port. Antenna 2211, interface 2214, and/or processing circuitry 2220 may be configured to perform any receiving or transmitting operations described herein as being performed by a wireless device. Any information, data and/or signals may be received from a network node and/or another wireless device. In some embodiments, radio front end circuitry and/or antenna 2211 may be considered an interface.

As illustrated, interface 2214 comprises radio front end circuitry 2212 and antenna 2211. Radio front end circuitry 2212 comprise one or more filters 2218 and amplifiers 2216. Radio front end circuitry 2214 is connected to antenna 2211 and processing circuitry 2220, and is configured to condition signals communicated between antenna 2211 and processing circuitry 2220. Radio front end circuitry 2212 may be coupled to or a part of antenna 2211. In some embodiments, wireless device 2210 may not include separate radio front end circuitry 2212; rather, processing circuitry 2220 may comprise radio front end circuitry and may be connected to antenna 2211. Similarly, in some embodiments, some or all of RF transceiver circuitry 2222 may be considered a part of interface 2214. Radio front end circuitry 2212 may receive digital data that is to be sent out to other network nodes or wireless devices via a wireless connection. Radio front end circuitry 2212 may convert the digital data into a radio signal having the appropriate channel and bandwidth parameters using a combination of filters 2218 and/or amplifiers 2216. The radio signal may then be transmitted via antenna 2211. Similarly, when receiving data, antenna 2211 may collect radio signals which are then converted into digital data by radio front end circuitry 2212. The digital data may be passed to processing circuitry 2220. In other embodiments, the interface may comprise different components and/or different combinations of components.

Processing circuitry 2220 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 2210 components, such as device readable medium 2230, wireless device 2210 functionality. Such functionality may include providing any of the various wireless features or benefits discussed herein. For example, processing circuitry 2220 may execute instructions stored in device readable medium 2230 or in memory within processing circuitry 2220 to provide the functionality disclosed herein.

As illustrated, processing circuitry 2220 includes one or more of RF transceiver circuitry 2222, baseband processing circuitry 2224, and application processing circuitry 2226. In other embodiments, the processing circuitry may comprise different components and/or different combinations of components. In certain embodiments processing circuitry 2220 of wireless device 2210 may comprise a SOC. In some embodiments, RF transceiver circuitry 2222, baseband processing circuitry 2224, and application processing circuitry 2226 may be on separate chips or sets of chips. In alternative embodiments, part or all of baseband processing circuitry 2224 and application processing circuitry 2226 may be combined into one chip or set of chips, and RF transceiver circuitry 2222 may be on a separate chip or set of chips. In still alternative embodiments, part or all of RF transceiver circuitry 2222 and baseband processing circuitry 2224 may be on the same chip or set of chips, and application processing circuitry 2226 may be on a separate chip or set of chips. In yet other alternative embodiments, part or all of RF transceiver circuitry 2222, baseband processing circuitry 2224, and application processing circuitry 2226 may be combined in the same chip or set of chips. In some embodiments, RF transceiver circuitry 2222 may be a part of interface 2214. RF transceiver circuitry 2222 may condition RF signals for processing circuitry 2220.

In certain embodiments, some or all of the functionality described herein as being performed by a wireless device may be provided by processing circuitry 2220 executing instructions stored on device readable medium 2230, which in certain embodiments may be a computer-readable storage medium. In alternative embodiments, some or all of the functionality may be provided by processing circuitry 2220 without executing instructions stored on a separate or discrete device readable storage medium, such as in a hard-wired manner. In any of those particular embodiments, whether executing instructions stored on a device readable storage medium or not, processing circuitry 2220 can be configured to perform the described functionality. The benefits provided by such functionality are not limited to processing circuitry 2220 alone or to other components of wireless device 2210, but are enjoyed by wireless device 2210 as a whole, and/or by end users and the wireless network generally.

Processing circuitry 2220 may be configured to perform any determining, calculating, or similar operations (e.g., certain obtaining operations) described herein as being performed by a wireless device. These operations, as performed by processing circuitry 2220, may include processing information obtained by processing circuitry 2220 by, for example, converting the obtained information into other information, comparing the obtained information or converted information to information stored by wireless device 2210, and/or performing one or more operations based on the obtained information or converted information, and as a result of said processing making a determination.

Device readable medium 2230 may be operable to store a computer program, software, an application including one or more of logic, rules, code, tables, etc. and/or other instructions capable of being executed by processing circuitry 2220. Device readable medium 2230 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 2220. In some embodiments, processing circuitry 2220 and device readable medium 2230 may be considered to be integrated.

User interface equipment 2232 may provide components that allow for a human user to interact with wireless device 2210. Such interaction may be of many forms, such as visual, audial, tactile, etc. User interface equipment 2232 may be operable to produce output to the user and to allow the user to provide input to wireless device 2210. The type of interaction may vary depending on the type of user interface equipment 2232 installed in wireless device 2210. For example, if wireless device 2210 is a smart phone, the interaction may be via a touch screen; if wireless device 2210 is a smart meter, the interaction may be through a screen that provides usage (e.g., the number of gallons used) or a speaker that provides an audible alert (e.g., if smoke is detected). User interface equipment 2232 may include input interfaces, devices and circuits, and output interfaces, devices and circuits. User interface equipment 2232 is configured to allow input of information into wireless device 2210, and is connected to processing circuitry 2220 to allow processing circuitry 2220 to process the input information. User interface equipment 2232 may include, for example, a microphone, a proximity or other sensor, keys/buttons, a touch display, one or more cameras, a USB port, or other input circuitry. User interface equipment 2232 is also configured to allow output of information from wireless device 2210, and to allow processing circuitry 2220 to output information from wireless device 2210. User interface equipment 2232 may include, for example, a speaker, a display, vibrating circuitry, a USB port, a headphone interface, or other output circuitry. Using one or more input and output interfaces, devices, and circuits, of user interface equipment 2232, wireless device 2210 may communicate with end users and/or the wireless network, and allow them to benefit from the functionality described herein.

Auxiliary equipment 2234 is operable to provide more specific functionality which may not be generally performed by wireless device s. This may comprise specialized sensors for doing measurements for various purposes, interfaces for additional types of communication such as wired communications etc. The inclusion and type of components of auxiliary equipment 2234 may vary depending on the embodiment and/or scenario.

Power source 2236 may, in some embodiments, be in the form of a battery or battery pack. Other types of power sources, such as an external power source (e.g., an electricity outlet), photovoltaic devices or power cells, may also be used. wireless device 2210 may further comprise power circuitry 2237 for delivering power from power source 2236 to the various parts of wireless device 2210 which need power from power source 2236 to carry out any functionality described or indicated herein. Power circuitry 2237 may in certain embodiments comprise power management circuitry. Power circuitry 2237 may additionally or alternatively be operable to receive power from an external power source; in which case wireless device 2210 may be connectable to the external power source (such as an electricity outlet) via input circuitry or an interface such as an electrical power cable. Power circuitry 2237 may also in certain embodiments be operable to deliver power from an external power source to power source 2236. This may be, for example, for the charging of power source 2236. Power circuitry 2237 may perform any formatting, converting, or other modification to the power from power source 2236 to make the power suitable for the respective components of wireless device 2210 to which power is supplied.

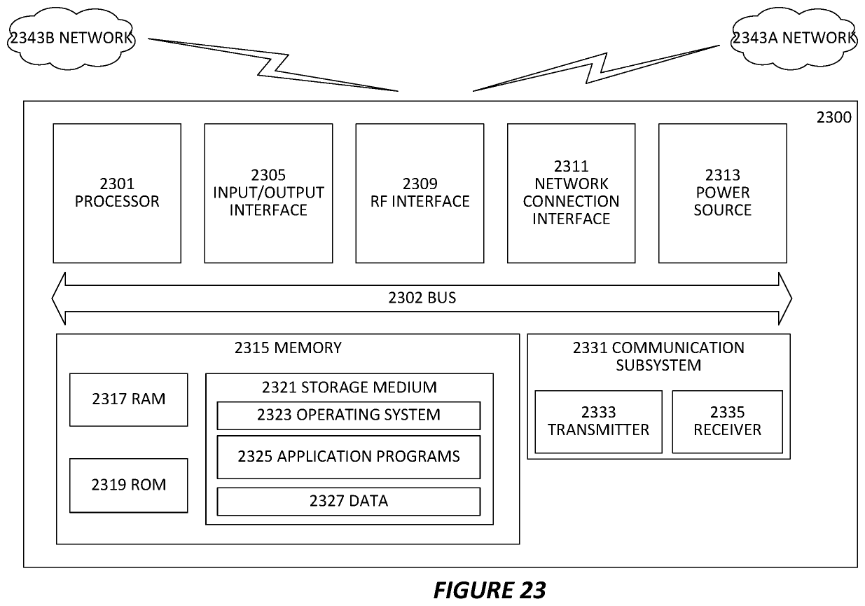

FIG. 23 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 23200 may be any UE identified by the 3rd Generation Partnership Project (3GPP), including a NB-IoT UE, a machine type communication (MTC) UE, and/or an enhanced MTC (cMTC) UE. UE 2300, as illustrated in FIG. 23, is one example of a wireless device configured for communication in accordance with one or more communication standards promulgated by the 3rd Generation Partnership Project (3GPP), such as 3GPP's GSM, UMTS, LTE, and/or 5G standards. As mentioned previously, the term wireless device and UE may be used interchangeably. Accordingly, although FIG. 23 is a UE, the components discussed herein are equally applicable to a wireless device, and vice-versa.

In FIG. 23, UE 2300 includes processing circuitry 2301 that is operatively coupled to input/output interface 2305, radio frequency (RF) interface 2309, network connection interface 2311, memory 2315 including random access memory (RAM) 2317, read-only memory (ROM) 2319, and storage medium 2321 or the like, communication subsystem 2331. power source 2333, and/or any other component, or any combination thereof. Storage medium 2321 includes operating system 2323, application program 2325, and data 2327. In other embodiments, storage medium 2321 may include other similar types of information.

Certain UEs may utilize all of the components shown in FIG. 23, or only a subset of the components. The level of integration between the components may vary from one UE to another UE. Further, certain UEs may contain multiple instances of a component, such as multiple processors, memories, transceivers, transmitters, receivers, etc.

In FIG. 23, processing circuitry 2301 may be configured to process computer instructions and data. Processing circuitry 2301 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2301 may include two central processing units (CPUs). Data may be information in a form suitable for use by a computer.

In the depicted embodiment, input/output interface 2305 may be configured to provide a communication interface to an input device, output device, or input and output device. UE 2300 may be configured to use an output device via input/output interface 2305. An output device may use the same type of interface port as an input device. For example, a USB port may be used to provide input to and output from UE 2300. The output device may be a speaker, a sound card, a video card, a display, a monitor, a printer, an actuator, an emitter, a smartcard, another output device, or any combination thereof. UE 2300 may be configured to use an input device via input/output interface 2305 to allow a user to capture information into UE 2300. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 23, RF interface 2309 may be configured to provide a communication interface to RF components such as a transmitter, a receiver, and an antenna. Network connection interface 2311 may be configured to provide a communication interface to network 2343a.

Network 2343a may encompass wired and/or wireless networks such as a local-area network (LAN), a wide-area network (WAN), a computer network, a wireless network, a telecommunications network, another like network or any combination thereof. For example, network 2343a may comprise a Wi-Fi network. Network connection interface 2311 may be configured to include a receiver and a transmitter interface used to communicate with one or more other devices over a communication network according to one or more communication protocols, such as Ethernet, TCP/IP, SONET, ATM, or the like. Network connection interface 2311 may implement receiver and transmitter functionality appropriate to the communication network links (e.g., optical, electrical, and the like). The transmitter and receiver functions may share circuit components, software or firmware, or alternatively may be implemented separately.

RAM 2317 may be configured to interface via bus 2302 to processing circuitry 2301 to provide storage or caching of data or computer instructions during the execution of software programs such as the operating system, application programs, and device drivers. ROM 2319 may be configured to provide computer instructions or data to processing circuitry 2301. For example, ROM 2319 may be configured to store invariant low-level system code or data for basic system functions such as basic input and output (I/O), startup, or reception of keystrokes from a keyboard that are stored in a non-volatile memory. Storage medium 2321 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2321 may be configured to include operating system 2323, application program 2325 such as a web browser application, a widget or gadget engine or another application, and data file 2327. Storage medium 2321 may store, for use by UE 2300, any of a variety of various operating systems or combinations of operating systems.

Storage medium 2321 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2321 may allow UE 2300 to access computer-executable instructions, application programs or the like, stored on transitory or non-transitory memory media, to off-load data, or to upload data. An article of manufacture, such as one utilizing a communication system may be tangibly embodied in storage medium 2321, which may comprise a device readable medium.

In FIG. 23, processing circuitry 2301 may be configured to communicate with network 2343b using communication subsystem 2331. Network 2343a and network 2343b may be the same network or networks or different network or networks. Communication subsystem 2331 may be configured to include one or more transceivers used to communicate with network 2343b. For example, communication subsystem 2331 may be configured to include one or more transceivers used to communicate with one or more remote transceivers of another device capable of wireless communication such as another wireless device, UE, or base station of a radio access network (RAN) according to one or more communication protocols, such as IEEE 802.11, CDMA, WCDMA, GSM, LTE, UTRAN, WiMax, or the like. Each transceiver may include transmitter 2333 and/or receiver 2335 to implement transmitter or receiver functionality, respectively, appropriate to the RAN links (e.g., frequency allocations and the like). Further, transmitter 2333 and receiver 2335 of each transceiver may share circuit components, software or firmware, or alternatively may be implemented separately.

In the illustrated embodiment, the communication functions of communication subsystem 2331 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 2331 may include cellular communication, Wi-Fi communication, Bluetooth communication, and GPS communication. Network 2343b may encompass wired and/or wireless networks such as a local-area network (LAN), a wide-area network (WAN), a computer network, a wireless network, a telecommunications network, another like network or any combination thereof. For example, network 2343b may be a cellular network, a Wi-Fi network, and/or a near-field network. Power source 2313 may be configured to provide alternating current (AC) or direct current (DC) power to components of UE 2300.

The features, benefits and/or functions described herein may be implemented in one of the components of UE 2300 or partitioned across multiple components of UE 2300. Further, the features, benefits, and/or functions described herein may be implemented in any combination of hardware, software or firmware. In one example, communication subsystem 2331 may be configured to include any of the components described herein. Further, processing circuitry 2301 may be configured to communicate with any of such components over bus 2302. In another example, any of such components may be represented by program instructions stored in memory that when executed by processing circuitry 2301 perform the corresponding functions described herein. In another example, the functionality of any of such components may be partitioned between processing circuitry 2301 and communication subsystem 2331. In another example, the non-computationally intensive functions of any of such components may be implemented in software or firmware and the computationally intensive functions may be implemented in hardware.

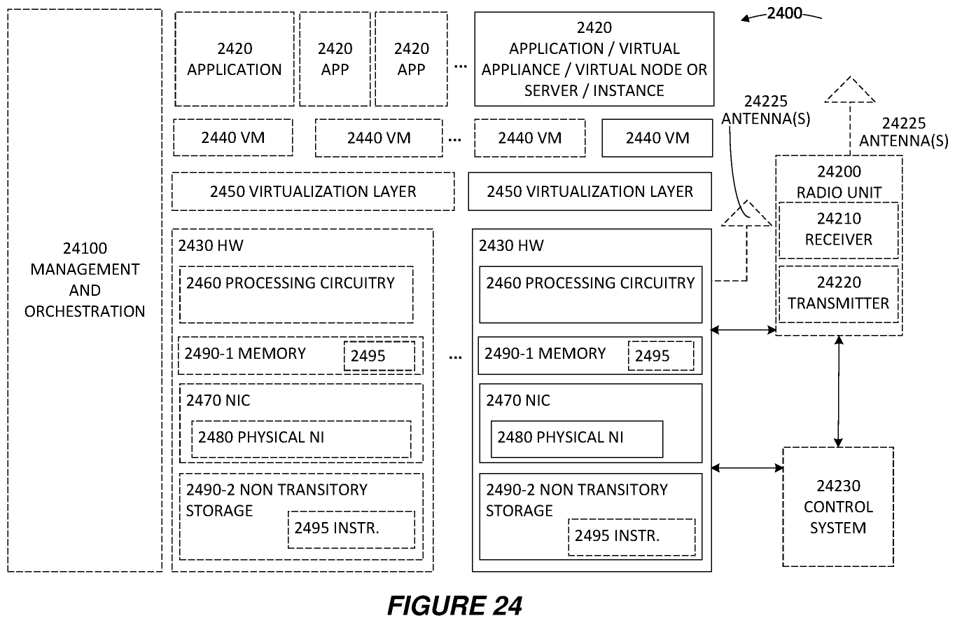

FIG. 24 is a schematic block diagram illustrating a virtualization environment 2400 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2400 hosted by one or more of hardware nodes 2430. Further, in embodiments in which the virtual node is not a radio access node or does not require radio connectivity (e.g., a core network node), then the network node may be entirely virtualized.

The functions may be implemented by one or more applications 2420 (which may alternatively be called software instances, virtual appliances, network functions, virtual nodes, virtual network functions, etc.) operative to implement some of the features, functions, and/or benefits of some of the embodiments disclosed herein. Applications 2420 are run in virtualization environment 2400 which provides hardware 2430 comprising processing circuitry 2460 and memory 2490. Memory 2490 contains instructions 2495 executable by processing circuitry 2460 whereby application 2420 is operative to provide one or more of the features, benefits, and/or functions disclosed herein.

Virtualization environment 2400, comprises general-purpose or special-purpose network hardware devices 2430 comprising a set of one or more processors or processing circuitry 2460, which may be commercial off-the-shelf (COTS) processors, dedicated Application Specific Integrated Circuits (ASICs), or any other type of processing circuitry including digital or analog hardware components or special purpose processors. Each hardware device may comprise memory 2490-1 which may be non-persistent memory for temporarily storing instructions 2495 or software executed by processing circuitry 2460. Each hardware device may comprise one or more network interface controllers (NICs) 2470, also known as network interface cards, which include physical network interface 2480. Each hardware device may also include non-transitory, persistent, machine-readable storage media 2490-2 having stored therein software 2495 and/or instructions executable by processing circuitry 2460. Software 2495 may include any type of software including software for instantiating one or more virtualization layers 2450 (also referred to as hypervisors), software to execute virtual machines 2440 as well as software allowing it to execute functions, features and/or benefits described in relation with some embodiments described herein.

Virtual machines 2440, comprise virtual processing, virtual memory, virtual networking or interface and virtual storage, and may be run by a corresponding virtualization layer 2450 or hypervisor. Different embodiments of the instance of virtual appliance 2420 may be implemented on one or more of virtual machines 2440, and the implementations may be made in different ways.

During operation, processing circuitry 2460 executes software 2495 to instantiate the hypervisor or virtualization layer 2450, which may sometimes be referred to as a virtual machine monitor (VMM). Virtualization layer 2450 may present a virtual operating platform that appears like networking hardware to virtual machine 2440.

As shown in FIG. 24, hardware 2430 may be a standalone network node with generic or specific components. Hardware 2430 may comprise antenna 24225 and may implement some functions via virtualization. Alternatively, hardware 2430 may be part of a larger cluster of hardware (e.g. such as in a data center or customer premise equipment (CPE)) where many hardware nodes work together and are managed via management and orchestration (MANO) 24100, which, among others, oversees lifecycle management of applications 2420.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2440 may be a software implementation of a physical machine that runs programs as if they were executing on a physical, non-virtualized machine. Each of virtual machines 2440, and that part of hardware 2430 that executes that virtual machine, be it hardware dedicated to that virtual machine and/or hardware shared by that virtual machine with others of the virtual machines 2440, forms a separate virtual network elements (VNE).

Still in the context of NFV, Virtual Network Function (VNF) is responsible for handling specific network functions that run in one or more virtual machines 2440 on top of hardware networking infrastructure 2430 and corresponds to application 2420 in FIG. 24.

In some embodiments, one or more radio units 24200 that each include one or more transmitters 24220 and one or more receivers 24210 may be coupled to one or more antennas 24225. Radio units 24200 may communicate directly with hardware nodes 2430 via one or more appropriate network interfaces and may be used in combination with the virtual components to provide a virtual node with radio capabilities, such as a radio access node or a base station.

In some embodiments, some signalling can be effected with the use of control system 24230 which may alternatively be used for communication between the hardware nodes 2430 and radio units 24200.

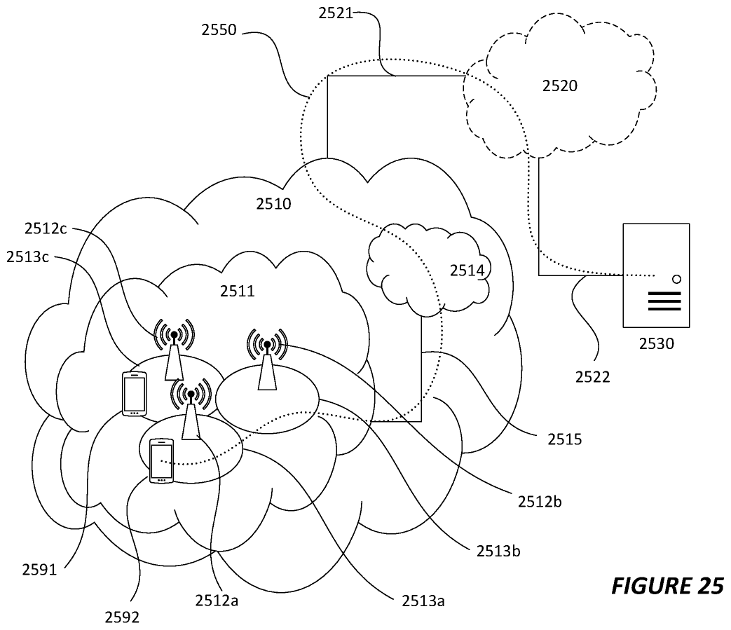

FIG. 25 illustrates a telecommunication network connected via an intermediate network to a host computer in accordance with some embodiments. In particular, with reference to FIG. 25, in accordance with an embodiment, a communication system includes telecommunication network 2510, such as a 3GPP-type cellular network, which comprises access network 2511, such as a radio access network, and core network 2514. Access network 2511 comprises a plurality of base stations 2512a, 2512b, 2512c, such as NBs, eNBs, gNBs or other types of wireless access points, each defining a corresponding coverage area 2513a, 2513b, 2513c. Each base station 2512a, 2512b, 2512c is connectable to core network 2514 over a wired or wireless connection 2515. A first UE 2591 located in coverage area 2513c is configured to wirelessly connect to, or be paged by, the corresponding base station 2512c. A second UE 2592 in coverage area 2513a is wirelessly connectable to the corresponding base station 2512a. While a plurality of UEs 2591, 2592 are illustrated in this example, the disclosed embodiments are equally applicable to a situation where a sole UE is in the coverage area or where a sole UE is connecting to the corresponding base station 2512.

Telecommunication network 2510 is itself connected to host computer 2530, which may be embodied in the hardware and/or software of a standalone server, a cloud-implemented server, a distributed server or as processing resources in a server farm. Host computer 2530 may be under the ownership or control of a service provider, or may be operated by the service provider or on behalf of the service provider. Connections 2521 and 2522 between telecommunication network 2510 and host computer 2530 may extend directly from core network 2514 to host computer 2530 or may go via an optional intermediate network 2520. Intermediate network 2520 may be one of, or a combination of more than one of, a public, private or hosted network; intermediate network 2520, if any, may be a backbone network or the Internet; in particular, intermediate network 2520 may comprise two or more sub-networks (not shown).

The communication system of FIG. 25 as a whole enables connectivity between the connected UEs 2591, 2592 and host computer 2530. The connectivity may be described as an over-the-top (OTT) connection 2550. Host computer 2530 and the connected UEs 2591, 2592 are configured to communicate data and/or signaling via OTT connection 2550, using access network 2511, core network 2514, any intermediate network 2520 and possible further infrastructure (not shown) as intermediaries. OTT connection 2550 may be transparent in the sense that the participating communication devices through which OTT connection 2550 passes are unaware of routing of uplink and downlink communications. For example, base station 2512 may not or need not be informed about the past routing of an incoming downlink communication with data originating from host computer 2530 to be forwarded (e.g., handed over) to a connected UE 2591. Similarly, base station 2512 need not be aware of the future routing of an outgoing uplink communication originating from the UE 2591 towards the host computer 2530.

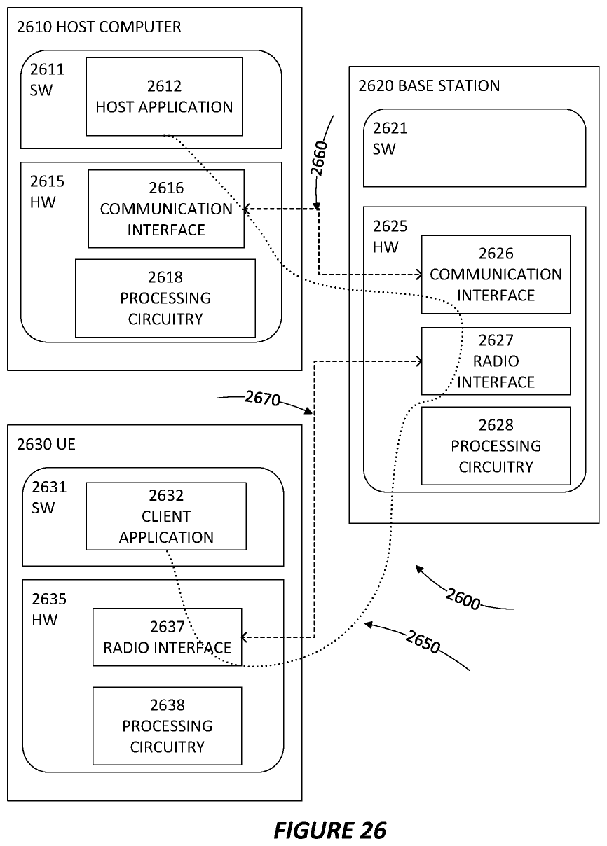

Example implementations, in accordance with an embodiment, of the UE, base station and host computer discussed in the preceding paragraphs will now be described with reference to FIG. 26. FIG. 26 illustrates host computer communicating via a base station with a user equipment over a partially wireless connection in accordance with some embodiments In communication system 2600, host computer 2610 comprises hardware 2615 including communication interface 2616 configured to set up and maintain a wired or wireless connection with an interface of a different communication device of communication system 2600. Host computer 2610 further comprises processing circuitry 2618, which may have storage and/or processing capabilities. In particular, processing circuitry 2618 may comprise one or more programmable processors, application-specific integrated circuits, field programmable gate arrays or combinations of these (not shown) adapted to execute instructions. Host computer 2610 further comprises software 2611, which is stored in or accessible by host computer 2610 and executable by processing circuitry 2618. Software 2611 includes host application 2612. Host application 2612 may be operable to provide a service to a remote user, such as UE 2630 connecting via OTT connection 2650 terminating at UE 2630 and host computer 2610. In providing the service to the remote user, host application 2612 may provide user data which is transmitted using OTT connection 2650.

Communication system 2600 further includes base station 2620 provided in a telecommunication system and comprising hardware 2625 enabling it to communicate with host computer 2610 and with UE 2630. Hardware 2625 may include communication interface 2626 for setting up and maintaining a wired or wireless connection with an interface of a different communication device of communication system 2600, as well as radio interface 2627 for setting up and maintaining at least wireless connection 2670 with UE 2630 located in a coverage area (not shown in FIG. 26) served by base station 2620. Communication interface 2626 may be configured to facilitate connection 2660 to host computer 2610. Connection 2660 may be direct or it may pass through a core network (not shown in FIG. 26) of the telecommunication system and/or through one or more intermediate networks outside the telecommunication system. In the embodiment shown, hardware 2625 of base station 2620 further includes processing circuitry 2628, which may comprise one or more programmable processors, application-specific integrated circuits, field programmable gate arrays or combinations of these (not shown) adapted to execute instructions. Base station 2620 further has software 2621 stored internally or accessible via an external connection.

Communication system 2600 further includes UE 2630 already referred to. Its hardware 2635 may include radio interface 2637 configured to set up and maintain wireless connection 2670 with a base station serving a coverage area in which UE 2630 is currently located. Hardware 2635 of UE 2630 further includes processing circuitry 2638, which may comprise one or more programmable processors, application-specific integrated circuits, field programmable gate arrays or combinations of these (not shown) adapted to execute instructions. UE 2630 further comprises software 2631, which is stored in or accessible by UE 2630 and executable by processing circuitry 2638. Software 2631 includes client application 2632. Client application 2632 may be operable to provide a service to a human or non-human user via UE 2630, with the support of host computer 2610. In host computer 2610, an executing host application 2612 may communicate with the executing client application 2632 via OTT connection 2650 terminating at UE 2630 and host computer 2610. In providing the service to the user, client application 2632 may receive request data from host application 2612 and provide user data in response to the request data. OTT connection 2650 may transfer both the request data and the user data. Client application 2632 may interact with the user to generate the user data that it provides.

It is noted that host computer 2610, base station 2620 and UE 2630 illustrated in FIG. 26 may be similar or identical to host computer 2530, one of base stations 2512a, 2512b, 2512c and one of UEs 2591, 2592 of FIG. 25, respectively. This is to say, the inner workings of these entities may be as shown in FIG. 26 and independently, the surrounding network topology may be that of FIG. 25.

In FIG. 26, OTT connection 2650 has been drawn abstractly to illustrate the communication between host computer 2610 and UE 2630 via base station 2620, without explicit reference to any intermediary devices and the precise routing of messages via these devices. Network infrastructure may determine the routing, which it may be configured to hide from UE 2630 or from the service provider operating host computer 2610, or both. While OTT connection 2650 is active, the network infrastructure may further take decisions by which it dynamically changes the routing (e.g., on the basis of load balancing consideration or reconfiguration of the network).

Wireless connection 2670 between UE 2630 and base station 2620 is in accordance with the teachings of the embodiments described throughout this disclosure. One or more of the various embodiments improve the performance of OTT services provided to UE 2630 using OTT connection 2650, in which wireless connection 2670 forms the last segment.

A measurement procedure may be provided for the purpose of monitoring data rate, latency and other factors on which the one or more embodiments improve. There may further be an optional network functionality for reconfiguring OTT connection 2650 between host computer 2610 and UE 2630, in response to variations in the measurement results. The measurement procedure and/or the network functionality for reconfiguring OTT connection 2650 may be implemented in software 2611 and hardware 2615 of host computer 2610 or in software 2631 and hardware 2635 of UE 2630, or both. In embodiments, sensors (not shown) may be deployed in or in association with communication devices through which OTT connection 2650 passes; the sensors may participate in the measurement procedure by supplying values of the monitored quantities exemplified above, or supplying values of other physical quantities from which software 2611, 2631 may compute or estimate the monitored quantities. The reconfiguring of OTT connection 2650 may include message format, retransmission settings, preferred routing etc.; the reconfiguring need not affect base station 2620, and it may be unknown or imperceptible to base station 2620. Such procedures and functionalities may be known and practiced in the art. In certain embodiments, measurements may involve proprietary UE signaling facilitating host computer 2610's measurements of throughput, propagation times, latency and the like. The measurements may be implemented in that software 2611 and 2631 causes messages to be transmitted, in particular empty or ‘dummy’ messages, using OTT connection 2650 while it monitors propagation times, errors etc.

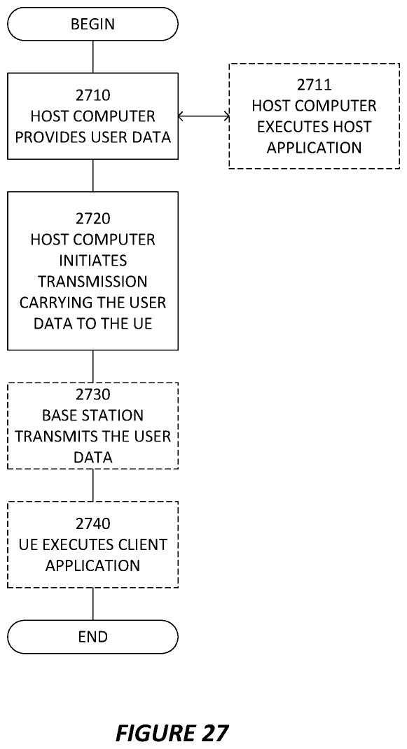

FIG. 27 is a flowchart illustrating a method implemented in a communication system, in accordance with one embodiment. The communication system includes a host computer, a base station and a UE which may be those described with reference to FIGS. 25 and 26. For simplicity of the present disclosure, only drawing references to FIG. 27 will be included in this section. In step 2710, the host computer provides user data. In substep 2711 (which may be optional) of step 2710, the host computer provides the user data by executing a host application. In step 2720, the host computer initiates a transmission carrying the user data to the UE. In step 2730 (which may be optional), the base station transmits to the UE the user data which was carried in the transmission that the host computer initiated, in accordance with the teachings of the embodiments described throughout this disclosure. In step 2740 (which may also be optional), the UE executes a client application associated with the host application executed by the host computer.

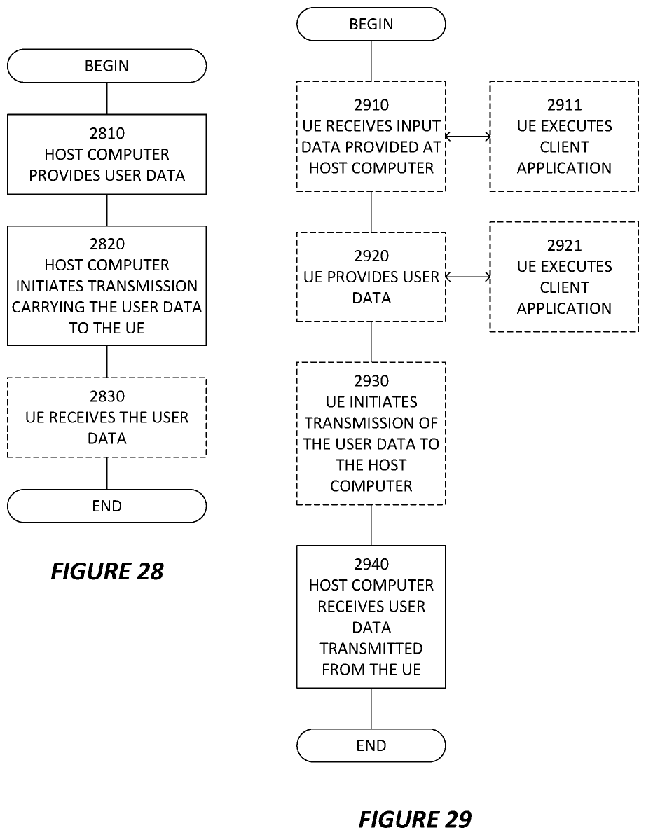

FIG. 28 is a flowchart illustrating a method implemented in a communication system, in accordance with one embodiment. The communication system includes a host computer, a base station and a UE which may be those described with reference to FIGS. 25 and 26. For simplicity of the present disclosure, only drawing references to FIG. 28 will be included in this section. In step 2810 of the method, the host computer provides user data. In an optional substep (not shown) the host computer provides the user data by executing a host application. In step 2820, the host computer initiates a transmission carrying the user data to the UE. The transmission may pass via the base station, in accordance with the teachings of the embodiments described throughout this disclosure. In step 2830 (which may be optional), the UE receives the user data carried in the transmission.

FIG. 29 is a flowchart illustrating a method implemented in a communication system, in accordance with one embodiment. The communication system includes a host computer, a base station and a UE which may be those described with reference to FIGS. 25 and 26. For simplicity of the present disclosure, only drawing references to FIG. 29 will be included in this section. In step 2910 (which may be optional), the UE receives input data provided by the host computer. Additionally or alternatively, in step 2920, the UE provides user data. In substep 2921 (which may be optional) of step 2920, the UE provides the user data by executing a client application. In substep 2911 (which may be optional) of step 2910, the UE executes a client application which provides the user data in reaction to the received input data provided by the host computer. In providing the user data, the executed client application may further consider user input received from the user. Regardless of the specific manner in which the user data was provided, the UE initiates, in substep 2930 (which may be optional), transmission of the user data to the host computer. In step 2940 of the method, the host computer receives the user data transmitted from the UE, in accordance with the teachings of the embodiments described throughout this disclosure.

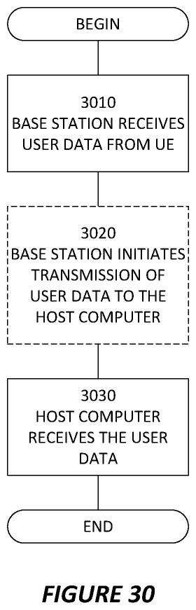

FIG. 30 is a flowchart illustrating a method implemented in a communication system, in accordance with one embodiment. The communication system includes a host computer, a base station and a UE which may be those described with reference to FIGS. 25 and 26. For simplicity of the present disclosure, only drawing references to FIG. 30 will be included in this section. In step 3010 (which may be optional), in accordance with the teachings of the embodiments described throughout this disclosure, the base station receives user data from the UE. In step 3020 (which may be optional), the base station initiates transmission of the received user data to the host computer. In step 3030 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

### Example Embodiments

Example embodiments of the techniques, apparatuses, and systems described above include, but are not limited to, the following enumerated examples:

### Group A:

A1. A method 1200 performed by a wireless device 20, the method 1200 comprising:
sending 1202 a periodic location report for a location management function (LMF) 54 of a wireless communication network 10, in accordance with configuration information, the periodic location report sent while operating within a geographic area 40 corresponding to assistance data provided to the wireless device 20, the periodic location report including a positioning measurement or location information; and
receiving 1204 incremental assistance data for use by the wireless device 20 in generating a next periodic location report, the incremental assistance data indicating a qualified subset of transmission/reception points (TRPs) 12 of the wireless communication network 10 that are associated with the geographic area 40 and, with respect to generation of the next periodic location report by the wireless device 20, are disallowed, allowed, or prioritized.

A2. The method 1200 of embodiment A1, further comprising performing a positioning measurement or a location procedure with respect to the next periodic location report, according to the incremental assistance information.

A3. The method 1200 of embodiment A1 or A2, further comprising receiving the assistance information via broadcasting in one or more cells 32 of the wireless communication network 10.

A4. The method 1200 of any of embodiments A1-A3, further comprising receiving the incremental assistance data via dedicated signaling from the wireless communication network 10, targeting the wireless device 20.

A5. The method 1200 of any of embodiments A1-A4, further comprising sending capability information towards the LMF 54, indicating support for deferred positioning procedures, and wherein sending the periodic location report is part of a deferred positioning procedure configured for the wireless device 20 by the LMF 54.

A6. The method 1200 of any of embodiments A1-A5, wherein the next periodic location report is one among successive periodic location reports, and wherein the method 1200 includes the wireless device 20 receiving respective incremental assistance data in advance of each successive periodic location report and using the respective incremental assistance data with respect to each successive periodic location report.

A7. The method 1200 of any of embodiments A1-A6, wherein the incremental assistance data indicates a positioning measurement or positioning method to use with respect to the next periodic location report, and wherein the method 1200 further comprises the wireless device 20 performing the indicated positioning measurement or positioning method, for the next periodic location report.

A8. The method 1200 of any of embodiments A1-A7, wherein the wireless device 20 sends the periodic location report as part of a deferred device-terminated or device-originated location request.

A9. A wireless device 20 configured for operation in a wireless communications network 10, the wireless device 20 comprising communication interface circuitry 100 and comprising processing circuitry 110, the processing circuitry 110 configured to perform any of the operations of any of the methods of embodiments A1-A8.

AA. The method 1200 of any of the preceding Group-A embodiments, further comprising:
providing user data; and
forwarding the user data to a host computer via the transmission to a base station.

### Group B:

B1. A method 1000 performed by a network node 54 associated with a wireless communication network 10, the method 1000 comprising:
receiving 1002 a periodic location report from a wireless device 20 configured for periodical location reporting while operating within a geographic area 40 corresponding to assistance data provided to the wireless device 20, the periodic location report including a positioning measurement or location information; and
sending 1004 incremental assistance data for use by the wireless device 20 in generating a next periodic location report, the incremental assistance data indicating a qualified subset of transmission/reception points (TRPs) 12 of the wireless communication network 10 that are associated with the geographic area 40 and, with respect to generation of the next periodic location report by the wireless device 20, are disallowed, allowed, or prioritized.

B2. The method 1000 of embodiment B1, wherein the next periodic location report is one among a succession of periodic location reports by the wireless device 20, and wherein the method 1000 includes sending respective incremental data to the wireless device 20 in advance of each successive location report.

B3. The method 1000 of embodiment B1 or B2, wherein the method 1000 further comprises providing the assistance data for the wireless device 20, and wherein the assistance data identifies TRPs 12 of the wireless communication network 10 that are associated with the geographic area 40.

B4. The method 1000 of embodiment B3, wherein the incremental assistance indicates the qualified subset of TRPs 12 from among the TRPs 12 that are associated with the geographic area 40.

B5. The method 1000 of any of embodiments B1-B4, wherein the incremental assistance data indicates the qualified subset of TRPs 12 using one or more of TRPs identifiers identifying respective TRPs 12 of the wireless communication network 10, cell identifiers identifying respective cells 32 of the wireless communication network 10, beam identifiers identifying respective beams 38 used by the wireless communication network 10, and frequency identifiers identifying respective radio carrier frequencies used by wireless communication network 10.

B6. The method 1000 of any of embodiments B1-B5, wherein the incremental assistance data indicates a positioning method or measurement to be performed by the wireless device 20 for the next periodic location report.

B7. The method 1000 of embodiment B6, wherein the method 1000 further comprises determining the positioning method or measurement to be performed by the wireless device 20 for the next periodic location report in dependence on at least one of the following: known or expected reception conditions of the wireless device 20 for the next periodic location report, or a known or expected geographic or network topology experienced by the wireless device 20 for the next periodic location report, or a known or expected location of the wireless device 20 for the next periodic location report.

B8. The method 1000 of any of embodiments B1-B7, wherein the incremental assistance data indicates the qualified subset of TRPs 12 by indicating one or more cells 32 of the wireless communication network 10 that, with respect to the next periodic location report by the wireless device 20, are disallowed, allowed, or prioritized, and wherein there is a one-to-one or one-to-many relationship between cells 32 and TRPs 12.

B9. The method 1000 of any of embodiments B1-B8, wherein the method 1000 further comprises predicting a location of the wireless device 20 with respect to the next periodic location report, and determining the incremental assistance data in dependence on the predicted location.

B10. The method 1000 of embodiment B8, wherein determining the incremental assistance data in dependence on the predicted location comprises determining the qualified subset in dependence on TRPs 12 of the wireless communication network 10 that are geographically relevant to the predicted location.

B11. The method 1000 of any of embodiments B1-B10, wherein the geographic area 40 is an area 40 for which deferred device-terminated or device-originated location requests are permitted.

B12. The method 1000 of any of embodiments B1-B11, wherein the geographic area 40 is an industrial area, and wherein the wireless device 20 is an Internet-of-Things (IoT) device that is affiliated with the industrial area.

B13. The method 1000 of any of embodiments B1-B12, wherein the method 1000 further comprises determining or adjusting the periodicity of periodical location reporting by the wireless device 20, based on including corresponding configuration information in the incremental assistance data.

B14. The method 1000 of embodiment B13, wherein the method 1000 further comprises determining or adjusting the periodicity of periodic location reporting by the wireless device 20 in dependence on any one or more of: a current location of the wireless device 20 within the geographic area 40, a known or expected next location of the wireless device 20 within the geographic area 40, a proximity of the wireless device 20 to outer boundaries of the geographic area 40 or internal sectional divisions within the geographic area 40, a known or expected rate of movement of the wireless device 20; a known or expected path of the wireless device 20; type information for the wireless device 20, or capability information from the wireless device 20.

B15. The method 1000 of any of embodiments B1-B14, further comprising determining the qualified subset of TRPs 12 in consideration of minimizing reporting latency.

B16. A network node configured for operation as an LMF 54 in a wireless communications network 10, the LMF 54 comprising communication interface circuitry 60 and comprising processing circuitry 66, the processing circuitry 66 configured to perform any of the operations of any of the methods of embodiments B1-B15.

BB. The method 1000 of any of the preceding Group-B embodiments, further comprising:
obtaining user data or location information relating to a wireless device 20 associated with the user data; and
forwarding the user data or location information to a host computer or the wireless device 20.

### Group C:

C1. A wireless device configured to perform any of the steps of any of the Group A embodiments.

C2. A wireless device comprising processing circuitry configured to perform any of the steps of any of the Group A embodiments.

C3. A wireless device comprising:
communication circuitry; and
processing circuitry configured to perform any of the steps of any of the Group A embodiments.

C4. A wireless device comprising:
processing circuitry configured to perform any of the steps of any of the Group A embodiments; and
power supply circuitry configured to supply power to the wireless device.

C5. A wireless device comprising:
processing circuitry and memory, the memory containing instructions executable by the processing circuitry whereby the wireless device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a wireless device, causes the wireless device to carry out the steps of any of the Group A embodiments.

C8. A carrier containing the computer program of embodiment C7, wherein the carrier is one of an electronic signal, optical signal, radio signal, or computer readable storage medium.

C9. A network node configured to perform any of the steps of any of the Group B embodiments.

C10. A network node comprising processing circuitry configured to perform any of the steps of any of the Group B embodiments.

C11. A network node comprising:
communication circuitry; and
processing circuitry configured to perform any of the steps of any of the Group B embodiments.

C12. A network node comprising:
processing circuitry configured to perform any of the steps of any of the Group B embodiments;
power supply circuitry configured to supply power to the network node.

C13. A network node comprising:
processing circuitry and memory, the memory containing instructions executable by the processing circuitry whereby the network node is configured to perform any of the steps of any of the Group B embodiments.

C14. The network node of any of embodiments C9-C13, wherein the network node is configured for operation as a Location Management Function (LMF) of a wireless communication network, and for communication with one or more radio network nodes of the wireless communication network and with one or more wireless devices operatively connected to any of the one or more radio network nodes.

C15. A computer program comprising instructions which, when executed by at least one processor of a network node, causes the network node to carry out the steps of any of the Group B embodiments.

C16. The computer program of embodiment C14, wherein the network node is a Location Management Function (LMF).

C17. A carrier containing the computer program of any of embodiments C15-C16, wherein the carrier is one of an electronic signal, optical signal, radio signal, or computer readable storage medium.

### Group D:

D1. A communication system including a host computer comprising:
processing circuitry configured to provide user data; and
a communication interface configured to forward the user data to a cellular network for transmission to a user equipment (UE),
wherein the cellular network comprises a network node having processing circuitry configured to perform any of the steps of any of the Group B embodiments.

D2. The communication system of the previous embodiment further including the network node.

D3. The communication system of the previous 2 embodiments, further including the UE, wherein the UE is configured to communicate with the network node.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a network node of a wireless communication network, and a user equipment (UE), the method comprising:
at the host computer, providing user data; and
at the host computer, initiating a transmission carrying the user data to the UE via a cellular network comprising the network node, wherein the network node performs any of the steps of any of the Group B embodiments.

D6. The method of the previous embodiment, wherein the user data is provided at the host computer by executing a host application, the method further comprising, at the UE, executing a client application associated with the host application.

D7. A user equipment (UE) configured to communicate with a base station of a wireless communication network, the UE comprising a radio interface and processing circuitry configured to perform of the previous embodiments.

D8. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D9. The communication system of the previous embodiment, wherein the cellular network further includes a base station configured to communicate with the UE.

D10. The communication system of the previous 2 embodiments, wherein:
the processing circuitry of the host computer is configured to execute a host application, thereby providing the user data; and
the UE's processing circuitry is configured to execute a client application associated with the host application.

D11. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D12. The method of the previous embodiment, further comprising at the UE, receiving the user data from the base station.

D13. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D14. The communication system of the previous embodiment, further including the UE.

D15. The communication system of the previous 2 embodiments, further including the base station, wherein the base station comprises a radio interface configured to communicate with the UE and a communication interface configured to forward to the host computer the user data carried by a transmission from the UE to the base station.

D16. The communication system of the previous 3 embodiments, wherein:
the processing circuitry of the host computer is configured to execute a host application; and
the UE's processing circuitry is configured to execute a client application associated with the host application, thereby providing the user data.

D17. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D18. A method implemented in a communication system including a host computer, a base station and a user equipment (UE), the method comprising:
at the host computer, receiving user data transmitted to the base station from the UE, wherein the UE performs any of the steps of any of the Group A embodiments.

D19. The method of the previous embodiment, further comprising, at the UE, providing the user data to the base station.

D20. The method of the previous 2 embodiments, further comprising:
at the UE, executing a client application, thereby providing the user data to be transmitted; and
at the host computer, executing a host application associated with the client application.

D21. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D22. A communication system including a host computer comprising a communication interface configured to receive user data originating from a transmission from a user equipment (UE) to a base station of a wireless communication network, wherein the wireless communication network includes a network node comprising a communication interface and processing circuitry that is configured to perform any of the steps of any of the Group B embodiments.

D23. The communication system of the previous embodiment further including the network node.

D24. The communication system of the previous 2 embodiments, further including the UE, wherein the UE is configured to communicate with the network node via the base station.

D25. The communication system of the previous 3 embodiments, wherein:
the processing circuitry of the host computer is configured to execute a host application;
the UE is configured to execute a client application associated with the host application, thereby providing the user data to be received by the host computer.

D26. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D27. The method of the previous embodiment, further comprising at the base station, receiving the user data from the UE.

D28. The method of the previous 2 embodiments, further comprising at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-30. (canceled)

31. A method performed by a wireless device, the method comprising:
sending a periodic location report for a location management function (LMF) of a wireless communication network, in accordance with configuration information, wherein the periodic location report is sent while the wireless device is operating within a geographic area corresponding to first assistance data received by the wireless device and the periodic location report includes positioning measurement or location information; and
receiving user equipment (UE)-specific assistance data for use by the wireless device in generating a next periodic location report, the UE-specific assistance data indicating a subset of transmission/reception points (TRPs), of the wireless communication network that are associated with the geographic area indicated in association with the first assistance data that are allowed to be used with respect to generation of the next periodic location report by the wireless device.

32. The method of claim 31, further comprising performing a positioning measurement or a location procedure with respect to the next periodic location report, according to the incremental assistance information.

33. The method of claim 31, wherein the first assistance data is received via broadcasting in one or more cells of the wireless communication network.

34. The method of claim 31, further comprising receiving the UE-specific assistance data via dedicated signaling from the wireless communication network, targeting the wireless device.

35. The method of claim 31, further comprising sending capability information towards the LMF, indicating support for deferred positioning procedures, and wherein sending the periodic location report is part of a deferred positioning procedure configured for the wireless device by the LMF, wherein the wireless device sends the periodic location report as part of a deferred device-terminated or device-originated location request.

36. A wireless device configured for operation in a wireless communications network, the wireless device comprising communication interface circuitry and comprising processing circuitry, the processing circuitry being configured to perform the method of claim 31.

37. A method performed by a network node associated with a wireless communication network, the method comprising:
receiving a periodic location report from a wireless device configured for periodical location reporting while operating within a geographic area corresponding to first assistance data received by the wireless device, the periodic location report including a positioning measurement or location information; and
sending second assistance data for use by the wireless device in generating a next periodic location report, the second assistance data indicating a qualified subset of transmission/reception points (TRPs) of the wireless communication network that are associated with the geographic area and, with respect to generation of the next periodic location report by the wireless device, that are disallowed, allowed, or prioritized.

38. The method of claim 37, wherein the second assistance data indicates the qualified subset of TRPs using one or more of TRPs identifiers identifying respective TRPs of the wireless communication network, cell identifiers identifying respective cells of the wireless communication network, beam identifiers identifying respective beams used by the wireless communication network, and frequency identifiers identifying respective radio carrier frequencies used by wireless communication network.

39. The method of claim 37, wherein the second assistance data is UE-specific assistance data and indicates a positioning method or measurement to be performed by the wireless device for the next periodic location report.

40. The method of claim 39, wherein the method further comprises determining the positioning method or measurement to be performed by the wireless device for the next periodic location report in dependence on at least one of the following: known or expected reception conditions of the wireless device for the next periodic location report, or a known or expected geographic or network topology experienced by the wireless device for the next periodic location report, or a known or expected location of the wireless device for the next periodic location report.

41. The method of claim 37, wherein the method further comprises predicting a location of the wireless device with respect to the next periodic location report and determining the second assistance data in dependence on the predicted location and determining the qualified subset in dependence on TRPs of the wireless communication network that are geographically relevant to the predicted location.

42. The method of claim 37, wherein the geographic area is an area for which deferred device-terminated or device-originated location requests are permitted.

43. The method of claim 37, wherein the second assistance data is sent to a base station, via an NRPPa positioning message.

44. A network node configured for operation as a Location Management Function (LMF) in a wireless communications network, the network node comprising communication interface circuitry and comprising processing circuitry, the processing circuitry configured to perform the method of claim 37.

45. A method performed by a base station associated with a wireless communication network, the method comprising:
sending first assistance data for use by a wireless device in generating a periodic location report while operating within a geographic area corresponding to the first assistance data; and
receiving, in an NRPPa positioning message, second assistance data for use by the wireless device in generating a next periodic location report, the second assistance data indicating a qualified subset of transmission/reception points, TRPs, of the wireless communication network that are associated with the geographic area and, with respect to generation of the next periodic location report by the wireless device, that are disallowed, allowed, or prioritized; and
performing UE associated measurement configuration based on the received second assistance data.

46. A network node configured for operation as a base station (gNB) in a wireless communications network, the network node comprising communication interface circuitry and comprising processing circuitry, the processing circuitry configured to:
send first assistance data for use by a wireless device in generating a periodic location report while operating within a geographic area corresponding to the first assistance data; and
receive, in an NRPPa positioning message, second assistance data for use by the wireless device in generating a next periodic location report, the second assistance data indicating a qualified subset of transmission/reception points (TRPs) of the wireless communication network that are associated with the geographic area and, with respect to generation of the next periodic location report by the wireless device, that are disallowed, allowed, or prioritized; and
perform UE associated measurement configuration based on the received second assistance data.
